(19) United States
(12) Patent Application Publication
(10) Pub. No.: US 2013/0011495 A1
(43) Pub. Date: Jan. 10, 2013

(54) ANTIFUNGAL COMPOUNDS AND USE THEREOF

(76) Inventors: Gabriel Roblin, Poitiers (FR); Estelle Luini, Touvre (FR)

(21) Appl. No.: 13/383,569

(22) PCT Filed: Jul. 15, 2010
(86) PCT No.: PCT/FR2010/051491

§ 371 Date: Aug. 17, 2012

(30) Foreign Application Priority Data
Jul. 15, 2009 (FR) 0903479

(51) Int. Cl. A01N 59/16; A01P 3/00; A01N 57/12

(52) U.S. Cl. 424/648; 514/141

(57) ABSTRACT

The present invention relates to an antifungal composition including at least two compounds selected from among the group consisting of cysteine, salicylic acid, iron(II) sulfate and fosetyl-aluminum, as well as to a method for treating a plant, infected or not infected by a pathogen. Specifically, the present invention relates to an antifungal composition for treating vineyards.

### TECHNICAL FIELD

The present invention relates to an antifungal composition and to a method of treating a plant infected by a pathogen. More particularly, the present invention relates to an antifungal composition for treating vines.

In the following description, the references in square brackets ([ ]) refer to the list of references given at the end of the text.

### PRIOR ART

Antimicrobial compositions have been known for several decades. They are compositions for killing microbes. Some of these antimicrobial compositions kill fungi and are called antifungals. There are various types of antifungals: so-called “natural” antifungals, which are compounds or compositions derived from plants, and from fruits (for example grapefruits); and antifungals produced by chemical synthesis.

A large number of antifungal substances are known in the prior art. We may mention for example amorolfine hydrochloride, amphotericin B, benzoic acid, benzyl hydroxybenzoate, bifonazole, boric acid, bromoxyquinone, buclosamine, caprylic acid, chlormidazole hydrochloride, chlorobutanol, chlorquinole, ciclopiroxolamine, clofenoxyde, cloprothiazole edisilate, clotrimazole, clotrimazole chloride, dequanilium chloride, dimazole hydrochloride, econazole nitrate, fenticonazole nitrate, etc.

The known antifungal compositions can be used in agriculture, for example for the prevention or treatment of pathologies such as esca, eutypiosis, mildew, oidium.

In the area of agriculture, the grapevine is a plant that requires massive recourse to plant protection treatments to keep numerous diseases in check. Thus, 30% of the tonnage of fungicides consumed in the European Union is used for viticulture, which only represents about 1% of the area under cultivation (Daire et al., 2002 (Ref 1)). These treatments are due to the strong parasitic pressure that is exerted on vines because only varieties of Vitis vinifera of European origin, which are much more sensitive to diseases, are authorized in most wine-producing regions and the vineyards are situated in temperate, humid zones favorable to the development of pathogenic fungi responsible for diseases.

The antifungal compositions of the prior art can also be used in the food-producing industry, for example in milk-based compositions in order to prevent and/or inhibit the development of fungi in yoghurts etc.; in the veterinary area, for example by topical application, intravenous administration in sheep, domestic animals, for example cats, dogs, etc., and in medicine, for example for the treatment of mycoses, by topical application, intravenous injection, subcutaneous injection etc.

One problem connected with the use of fungicides is appearance of phenomena of resistance. In fact, the massive use of fungicides leads to the appearance of “resistant strains” just as is observed with antibiotics. These resistant strains necessitate constant research to find new compounds that are able to inhibit the growth of fungi.

Moreover, it is well known that fungicides possessing a single site of action (unisite fungicide) such as benzimidazoles (Benlate (brand name)), favor the development of resistance, whereas fungicides possessing multiple sites of action (multisite fungicides) such as dithiocarbamates (Ferbam (brand name)) make it possible to limit the appearance of the phenomenon of resistance.

Another known drawback of fungicides is their toxicity. In fact, it is known that the fungicides used in agriculture can be toxic to insects, for example bees, but also to aquatic organisms. An example is Zirane (brand name).

Finally, owing to their toxicity, certain fungicides have been withdrawn from commercial use, for example sodium arsenite. This compound has a broad spectrum of action, being effective against four families of pathogenic fungi (Ascomycetes, Basidiomycetes, Deuteromycetes and Oomycetes). It has been used for the treatment and prevention of esca, a complex pathology caused by several fungi of the Ascomycetes and Basidiomycetes classes that infect woody plants, for example vines. This compound has been banned as it is carcinogenic and toxic to humans. At present there are no compounds for treating esca.

Salicylic acid (SA) is a molecule involved in the defense reactions of plants. Initially, it was shown that aspirin, a derivative of SA, could induce SAR (systemic acquired resistance) and the synthesis of PR (“pathogenesis related”) proteins (White, 1979 (Ref 2)), imitating the action of a natural benzoic compound acting as a defense signal (Van Loon, 1983 (Ref 3)). It was only in 1990 that it was demonstrated that SA is an essential element in the induction of SAR (Malamy et al., 1990 (Ref 4); Métraux et al., 1990 (Ref 5)). SA stimulates the production of glucanases and chitinases which are transported to the distal parts of the plant where they degrade the fungal or bacterial cell wall (Kessmann et al., 1996 (Ref 6)). SA also possesses antifungal properties against Eutypa lata. This action is dependent on the pH and the threshold value is estimated at 0.1 mM at pH 4.1 (Amborabé et al., 2002 (Ref 7)).

The use of SA has been envisaged as elicitor against pathogens in crop protection (Regnault-Roger C, 2006 (Ref 8)). SA has a phloem and xylem systemic action on castor-oil plantlets. SA labeled with ¹⁴C and at a concentration of 10 μM is detected in phloem sap at a concentration of 100 μM and in xylem sap at 0.67 μM after 4 hours of absorption (Rocher et al., 2006 (Ref 9)). The concentration factor of SA in the castor-oil plant phloem is of the order of 10, for pH between 4.6 and 5.0 (Rocher, 2004 (Ref 10)).

Analogs of SA have also been synthesized: 2,6-dichloroisonicotinic acid (INA) and acibenzolar-S-methyl (ASM), which is a benzothiadiazole (see formulas (II) and (III)). These molecules are capable of inducing SAR (Dong, 1998 (Ref 11)).

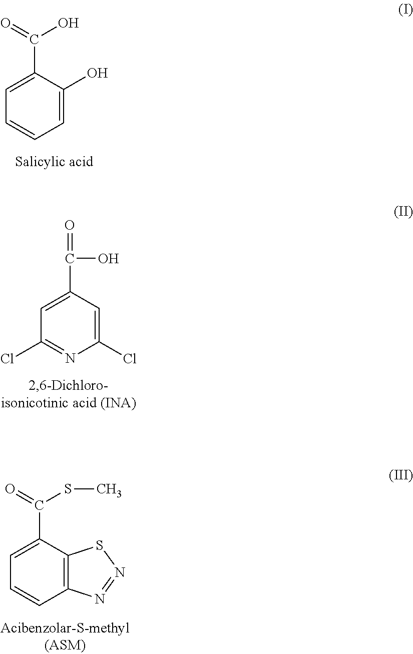

INA was soon abandoned on account of its phytotoxicity. In contrast, the efficacy of ASM has been demonstrated in many annual plants (cereals, potato, tomato) with respect to various pathogens such as fungi, viruses and bacteria (Van Toor et al., 2001 (Ref 12)). It was introduced in 1996 as activator of defenses for controlling oidium of cereals in Germany and in Switzerland (Ruess et al., 1996 (Ref 13)) and is also used against pyraculariosis of rice and various mildews (Ishii et al., 1999 (Ref 14); Leroux, 2003 (Ref 15)). It also possesses antibacterial and antiviral activity. Few studies have been conducted on perennial plants (Brisset et al., 2005 (Ref 16)). ASM was put on the market under the trade name “Bion” but in practice, this molecule did not show the expected efficacy (Alabouvette et al., 2003 (Ref 17)). It has been demonstrated that INA and ASM do not directly induce defense reactions but lower the threshold of response to a fungal elicitor (Conrath et al., 2002 (Ref 18)).

At present, the method of application used consists of injecting salicylate salts into the wood of the vine plant for combating Eutypa lata and Chondostereum purpureum (Spiers and Ward, 2001 (Ref 19)). The injection of salicylic acid in the form of potassium salts (18.5 g/L) into the trunk of cv. Sauvignon plants showed an interesting effect on esca (45.4% efficacy), the percentage of re-expression of the symptoms being much lower for the treated plants than for the controls. However, the efficacy of the product is not maintained, since eighteen months after its application, the number of plants expressing esca is identical in the control batch and in the treated batch (Larignon and Molot, 2004 (Ref 20)).

Cysteine is an amino acid which possesses a thiol group (formula (IV)) and which is present in most proteins. Although represented at a low level, its presence in the composition of the proteins is very important, notably because it makes it possible to form disulfide bridges.

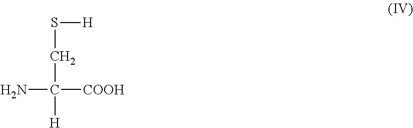

Cysteine may be involved in defense phenomena since it has been shown that when tomato stems are infected with Verticillium dahliae, the concentrations of cysteine, sulfate and glutathione increase in the tissues (Williams et al., 2002 (Ref 21)).

Various works have shown that cysteine possesses an antifungal activity against certain fungi. Thus, cysteine, applied at concentrations of 0.9 and 9 mM, inhibits the development of Inonotus obliquus (Kahlos and Tikka, 1994 (Ref 22)). Comparable results were obtained with Eutypa lata, the pathogen of grapevine eutypiosis. Cysteine inhibits mycelial development and also induces death of Eutypa lata (Octave et al., 2005 (Ref 23)). It has also been shown that cysteine inhibits the germination of the spores of Alternaria cassiae, Alternaria crassa and Alternaria macrospora (Daigle and Cotty, 1991 (Ref 24)).

Cysteine possesses another action since it causes, in Inonotus obliquus and in Eutypa lata, a salting out of ergosterol (Kahlos and Tikka, 1994 (Ref 22)); Octave et al., 2005 (Ref 23)) which is a sterol of fungal origin known to be a nonspecific elicitor capable of activating the plant's defense reactions (Granado et al., 1995 (Ref 24); Amborabé, 2000 (Ref 26); Amborabé et al., 2003 (Ref 27); Luini, 2003 (Ref 28); Rossard, 2003 (Ref 29)). The activity of cysteine is closely linked to its structure. In fact, a structural modification or a change of the —SH chemical function cancels its efficacy. Foliar disks and leaves isolated from various plant species exposed to L-cysteine emit SH₂, a volatile compound, potentially possessing antifungal activity (Sekiya et al., 1982 (Ref 30)). Exogenous supply of cysteine to leaf disks of poplar increases the content of glutathione and of α-glutamylcysteine, two molecules involved in protecting cells against the active forms of oxygen in defense reactions (Noctor et al., 1996 (Ref 31)).

However, cysteine alone is not sufficient for use as fungicide, since even if it displays inhibitory activity on pathogen growth in vitro, its activity in vivo has not been demonstrated.

The importance of iron in the relations that are established between various pathogenic microorganisms (bacteria, fungi) and their hosts has been emphasized in many studies (Weinberg, 1966 (Ref 32)). In the Botrytis cinerea/Vicia faba interaction, iron chelating agents such as EDTA (ethylenediamine tetraacetic acid) and DHBA (dihydroxy benzoic acid) increase the aggressiveness of the conidia of Botrytis cinerea. Addition of ferric sulfate (Fe₂(SO₄)₃) to the inoculum treated with these chelating agents reduces this aggressiveness (Brown and Swinburne, 1982 (Ref 33)). The presence of iron sulfate inhibits the formation and development of necrotic lesions caused by Botrytis fabae and Botrytis cinerea on detached leaves of Vicia faba (Vedie and Le Normand, 1984 (Ref 34)).

In viticulture, iron sulfate is supplied to the grapevine to combat iron deficiencies that are responsible for chloroses. Chloroses are combated by supply in the soil or on the leaves. It should be noted that the recommended supply via the soil is 1 kg/stem with 10 L of solvent (10%) (water or vinasse) whereas in foliar spraying, iron sulfate is used at 1% for a volume of water of 300 L/ha.

Fosetyl-aluminum (aluminum tris-o-ethylphosphonate), initially tested as an antitranspiration agent, has shown a protective effect with respect to grapevine mildew and is used against many species of Phytophthora. It inhibits germination of the sporangium and penetration of the mycelium into the plant. It also limits mycelial development and the sporulation of Plasmopara viticola, the agent of grapevine mildew (Gouot, 2006 (Ref 35)). The phosphonates do not display fungicidal or fungistatic activity when they are used alone, but inhibition of growth of Phaeomoniella chlamydospora is noted when they are combined with resveratrol (Mazullo et al., 2000 (Ref 36)).

The plant decomposes fosetyl-aluminum to phosphorous acid and ethanol and then to phosphonic acid on absorption (Leconte et al., 1988 (Ref 37)) (see scheme V).

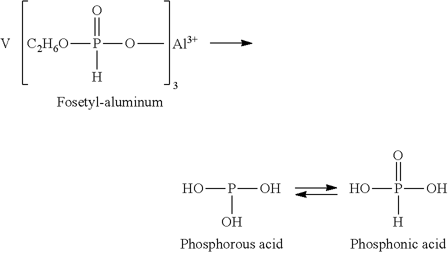

Fosetyl-aluminum stimulates plants' defense system. In preventive use, it potentiates the plant's defense reactions and prepares the cells for later attack by a pathogen. The phosphonates act at the level of phosphate metabolism of the fungi and cause elicitors to be produced in larger amounts (Leroux, 2000 (Ref 38)). This hyper-elicitation causes increased synthesis of signal molecules such as jasmonic acid, ethylene and salicylic acid and accelerated transcription of the defense genes resulting in synthesis of phytoalexins (resveratrol, ε-viniferin), of phenolic compounds, of PR proteins such as chitinases and glucanases (Dercks and Creasy, 1989 (Ref 39); Lacombe, 2003 (Ref 40); Molina et al., 1998 (Ref 40); Nemestothy and Guest, 1990 (Ref 42); Serrano et al., 1994 (Ref 43)).

Fosetyl-aluminum and phosphonic acid are ambimobile systemic products (Leconte et al., 1988 (Ref 37); Leroux, 2000 (Ref 38); Leroux, 2003 (Ref 44)). The transport of fosetyl-aluminum, investigated on cotyledons of Ricinus communis L., is similar to that of sucrose in plants. It is detected in the phloem exudate 30 min after application. Maximum absorption occurs at pH 5.0. It is also detected in root exudates of Lycopersicon esculentum Mil. and Persea indica L. in hydroponic culture (Ouimette and Coffey, 1990 (Ref 45)).

There have been various studies of the effect of fosetyl-aluminum on vines affected by esca. Greenhouse tests showed that five treatments performed with fosetyl-aluminum (Aliette 80 WP) on 2-year-old vines, followed by inoculation with Phaeomoniella chlamydospora and Phaeoacremonium aleophilum make it possible to reduce the area of necroses in the wood relative to untreated vines. The two fungi are isolated after treatment (Di Marco et al., 2000 (Ref 46); Mazullo et al., 2000 (Ref 47); Di Marco and Osti, 2005 (Ref 48)). Experiments combining fosetyl-aluminum with mancozeb, with cimoxanil and/or with copper oxychloride, performed in the vineyard, lead to a decrease in the number of plants expressing foliar symptoms. In contrast, fosetyl-aluminum has no influence on the number of dead stems (Di Marco and Osti, 2005 (Ref 48)). These results demonstrate that this compound is not fungicidal with respect to fungi involved in diseases of the wood.

There is therefore a real need to find new fungicidal compositions for overcoming these faults, drawbacks and obstacles of the prior art, in particular a method for controlling the amounts of fungicides administered, to reduce costs, and improve the efficacy of the fungicides in order to inhibit the development of the pathogens completely. This also makes it possible to limit the amount of the different active substances used in order to reduce the toxicity and the environmental impact of the fungicides.

### DESCRIPTION OF THE INVENTION

The present invention has precisely the aim of responding to the needs and drawbacks of the prior art by providing an antifungal composition.

The present invention relates to an antifungal composition comprising at least two of the compounds selected from the group comprising cysteine, salicylic acid, iron(II) sulfate and fosetyl-aluminum.

The inventors have discovered, surprisingly and unexpectedly, that the composition of the invention has an antifungal activity far greater than those of the prior art and can thus provide an antifungal effect with a composition with small amounts of compounds.

Moreover, the inventors have demonstrated that the compounds used in the composition of the invention have a synergy of action, which can also make it possible to reduce the emergence of “resistant strains”.

Preferably, the composition of the invention comprises at least three compounds selected from the group comprising cysteine, salicylic acid, iron(II) sulfate and fosetyl-aluminum.

Even more preferably, the composition of the invention comprises cysteine, salicylic acid, iron(II) sulfate and fosetyl-aluminum.

In the present text, “antifungal” means a molecule that acts against pathologies caused by fungi, bacteria, phytoplasmas, viruses, yeasts, preferably fungi and/or yeasts.

Preferably, the composition is a fungicidal and/or fungistatic composition.

According to the present invention, “fungicidal” means a composition that is capable of causing the death of fungi, bacteria, phytoplasmas, viruses, yeasts, preferably fungi and/or yeasts.

According to the present invention, “fungistatic” means a composition that is capable of stopping the growth of fungi, bacteria, phytoplasmas, viruses, yeasts, preferably fungi and/or yeasts.

In the present text, “cysteine” means a natural α-amino acid or an amino acid obtained by chemical synthesis which possesses a sulfhydryl or thiol group (SH). For example, it can be L-cysteine of the following formula (IV):

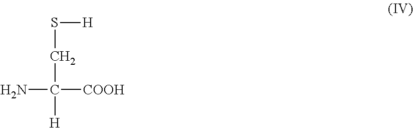

D-cysteine, an amino acid derived from cysteine, for example acetylcysteine, carbocysteine or carboxymethyl cysteine, or any other molecule derived from cysteine and which retains a cysteine radical.

According to the invention, the concentration of cysteine in the composition of the invention can be between 0.01 and 150 mM. Preferably, the concentration of cysteine is between 1 and 120 mM, even more preferably between 4 and 65 mM.

In the present text, “salicylic acid” means 2-hydroxybenzoic acid or a derivative thereof. For example, salicylic acid can be synthesized naturally, for example extracted from white willow bark, or by chemical synthesis, for example according to the Kolbe (or Kolbe-Schmitt) reaction.

According to the invention, the concentration of salicylic acid in the composition of the invention can be between 0.01 and 4 mM. Preferably, the concentration of salicylic acid can be between 0.1 and 3 mM, more preferably between 0.4 and 1.5 mM.

In the present text, “iron(II) sulfate” means the compound of formula FeSO₄ or a derivative thereof. For example, it can be hydrated iron sulfate (FeSO₄, nH₂O), iron sulfate heptahydrate (FeSO₄.7H₂O), or other iron salts such as iron chloride (FeCl₂), iron acetate (Fe(CH₃CO₂)₂).

According to the invention, the concentration of iron(II) sulfate in the composition of the invention can be between 0.01 and 160 mM. Preferably, the concentration of iron(II) sulfate can be between 3 and 120 mM, more preferably between 4 and 65 mM.

In the present text, “fosetyl-aluminum” means aluminum ethyl hydrogen phosphonate, or aluminum tris(ethylphosphonate), or aluminum tris-O-ethylphosphonate, C₆H₁₈AlO₉P₃.

According to the invention, the concentration of fosetyl-aluminum in the composition of the invention can be between 0.01 and 81 mM. Preferably, the concentration of fosetyl-aluminum can be between 1 and 55 mM, more preferably between 2 and 30 mM.

According to the invention, the upper limits of amounts of the different products were determined in tests of phytotoxicity. First symptoms appear on the leaves at these amounts. The aforementioned ranges of values are therefore those that are recommended so that generally there are no symptoms on the leaves. These amounts can be slightly different or even greater depending on the sensitivity of the plant. A person skilled in the art will easily know how to determine the amounts.

According to the invention, the pH of the composition of the present invention can be modified so that it is acid.

According to the invention, modification can be effected by any means known by a person skilled in the art, for example by adding an acid solution, for example HCl, H₂CO₃.

According to the invention, the pH of the composition can be for example less than 7, for example from 4 to 6, preferably from 4.5 to 5.

A pH of the composition can advantageously provide a further increase in antifungal efficacy.

According to the invention, the pH of the composition can be determined by any method known by a person skilled in the art, for example by means of a pH-meter.

According to the invention, the composition can be for agricultural, veterinary and/or medical use.

According to the invention, the composition can be in a liquid form, an emulsion, an ointment, a foam, a paste, a powder or a gel.

The composition of the invention can be manufactured by any method known by a person skilled in the art. It can for example be simple mixing, preferably leading to a homogeneous composition.

The invention also relates to a method of treating a plant comprising application of the composition of the present invention.

The invention also relates to a method of treatment and/or preventive treatment comprising application of the composition of the present invention on a plant infected by a pathogen and/or on a plant that is at risk of infection by a pathogen.

Application is as defined below.

In the present text, “plant” means any living vegetable fixed in the earth and whose upper part spreads in the air or in fresh water. For example, it can be woody plants, for example indigenous woody species, vines, for example plants of the grape varieties Aligoté, Auxerrois, Cabernet franc, Cabernet-Sauvignon, Carmenère, Chardonnay, Colombard, Folignan, Folle blanche, Gamay, Gewurztraminer, Grenache, Jurançon blanc, Malbec, Merlot, Meslier Saint François, Montils, Muscadelle, Muscadet, Petit verdot, Pinots, Poulsard, Riesling, Sauvignon, Savagnin, Sélect, Sémillon, Sylvaner, Syrah, Tokay, Trousseau, Ugni blanc.

According to the invention, “treatment” means for example at least one application of the composition of the invention, for example in a form as described above, able to prevent or stop an infection, for example by stopping the growth of the pathogen and/or by the death of the pathogen.

According to the invention, “preventive treatment” means for example at least one application of the composition of the invention, for example in a form as described above, able to prevent or stop an infection, for example by preventing the appearance of an infection by a pathogen, by stopping the growth of the pathogen and/or by the death of the pathogen.

In the present invention, “pathogen” means an agent selected from the group comprising fungi, bacteria, phytoplasmas, viruses and yeasts. For example, it can be the fungi Phaeomoniella chlamydospora, Phaeocremonium aleopholilum, Fomitiporia mediterranea, Strereum hirsutum, Phellinus igniarius, Eutypa lata, Botryosphaeria obtusa, Neofusicoccum parvum, Botryosphaeria dothidea, Botryosphaeria stevensii, Phomopsis viticole, Plasmopara viticola, Botrytis cinerea, Erysiphe necator. Preferably, the fungi Phaeomoniella chlamydospora and Phaeocremonium aleopholilum.

According to the method of the invention, application of the composition of the invention can be carried out by any means known by a person skilled in the art. For example, the composition can be applied by spraying the plant, watering, atomizing, painting, dipping, dusting.

According to the invention, application of the composition can be carried out with various devices, for example with any type of agricultural sprayer known by a person skilled in the art. A person skilled in the art will easily be able to determine the type of sprayer that can be used, for example it can be a tractor-drawn pneumatic sprayer.

According to the invention, application of the composition can be programmed, for example by means of an automatic programming device with daily, weekly, or monthly application.

According to the invention, application of the composition can be carried out so as to maintain a constant amount of the composition at plant level, for example application can be carried out at least once a month, once a week, or once a day. A person skilled in the art will easily be able to adapt the application of the composition according to the plant and/or the constant amount to be maintained.

Other advantages may also become apparent to a person skilled in the art on reading the examples given below, illustrated by the accompanying drawings, given for purposes of illustration.

### BRIEF DESCRIPTION OF THE DRAWINGS

FIG. 1 is a diagram showing mycelial growth in mm on solid medium (YNB, glucose 50 mM, glutamine (Gln) 40 mM, MES 10 mM, pH 5.5) as a function of the incubation time. More particularly, this diagram shows the kinetics of growth of Phaeomoniella chlamydospora (Pch) and Phaeoacremonium aleophilum (Pal).

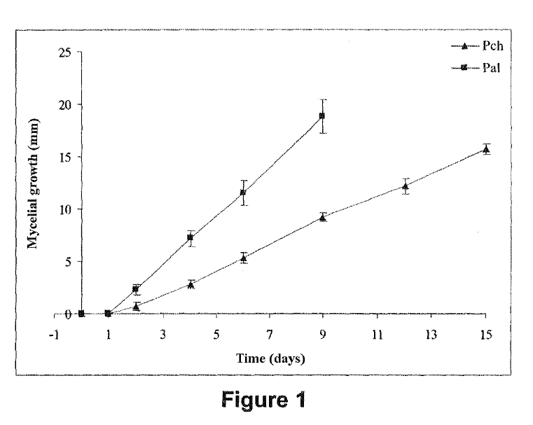

FIG. 2 is a diagram showing mycelial growth in mm of Phaeomoniella chlamydospora at 18 days (A) and Phaeoacremonium aleophilum at 12 days (B) on a solid medium (YNB, glucose 50 mM, glutamine 40 mM, HEPES 10 mM, pH 4.2) as a function of the concentration of cysteine (Cys) in the medium.

FIG. 3 is a diagram showing mycelial growth in mm of Phaeomoniella chlamydospora at 18 days (A) and Phaeoacremonium aleophilum at 12 days (B) on a solid medium (YNB, glucose 50 mM, glutamine 40 mM, HEPES 10 mM, pH 4.2) as a function of the presence of various sulfates in the medium at a concentration of 40 mM: sulfates of ammonium (NH₄2(SO₄)), of potassium (K₂SO₄), of magnesium (MgSO₄), of iron (FeSO₄) and of copper (CuSO₄).

FIG. 4 is a diagram showing mycelial growth in mm of Phaeomoniella chlamydospora at 18 days (A) and Phaeoacremonium aleophilum at 12 days (B) on a solid medium (YNB, glucose 50 mM, glutamine 40 mM, HEPES 10 mM, pH 4.2) as a function of the concentration of iron sulfate (FeSO₄) in the medium.

FIG. 5 is a diagram showing mycelial growth in mm of Phaeomoniella chlamydospora at 18 days (A) and Phaeoacremonium aleophilum at 12 days (B) on a solid medium (YNB, glucose 50 mM, glutamine 40 mM, HEPES 10 mM, pH 4.2) as a function of different concentrations of iron sulfate (FeSO₄), iron chloride (FeCl₂) and iron acetate (Fe(CH₃CO₂)₂) in the medium.

FIG. 6 is a diagram showing mycelial growth in mm of Phaeomoniella chlamydospora at 18 days (A) and Phaeoacremonium aleophilum at 12 days (B) on a solid medium (YNB, glucose 50 mM, glutamine 40 mM, HEPES 10 mM, pH 4.2) as a function of different concentrations of salicylic acid (SA) in the medium.

FIG. 7 is a diagram showing mycelial growth in mm of Phaeomoniella chlamydospora at 18 days (A) and Phaeoacremonium aleophilum at 12 days (B) on a solid medium (YNB, glucose 50 mM, glutamine 40 mM, HEPES 10 mM, pH 4.2) as a function of different concentrations of fosetyl-aluminum in the medium.

FIG. 8 is a diagram showing the effect of combining cysteine with different concentrations of salicylic acid on mycelial growth in mm of Phaeomoniella chlamydospora at 18 days (A) and Phaeoacremonium aleophilum at 12 days (B) on a solid medium (YNB, glucose 50 mM, glutamine 40 mM, HEPES 10 mM, pH 4.2). More particularly, the different conditions of incubation are 5 mM of cysteine (Cys) and different concentrations of salicylic acid (SA), used alone (I) or combined (IIa).

FIG. 9 is a diagram showing the effect of combining cysteine and salicylic acid with different concentrations of iron sulfate on mycelial growth in mm of Phaeomoniella chlamydospora at 18 days (A) and Phaeoacremonium aleophilum at 12 days (B) on a solid medium (YNB, glucose 50 mM, glutamine 40 mM, HEPES 10 mM, pH 4.2). More particularly, the different conditions of incubation are 5 mM of cysteine (Cys), 0.5 mM of salicylic acid (SA) and different concentrations of iron sulfate (FeSO₄), used alone (I) or combined by 2 (II) or 3 (III).

FIG. 10 is a diagram showing the effect of combining cysteine, salicylic acid, iron sulfate and fosetyl-aluminum on mycelial growth in mm of Phaeomoniella chlamydospora at 21 days (A) and Phaeoacremonium aleophilum at 13 days (B) on a solid medium (YNB, glucose 50 mM, glutamine 40 mM, HEPES 10 mM, pH 4.2). More particularly, the different conditions of incubation are 5 mM of cysteine (Cys), 0.5 mM of salicylic acid (SA), 5 mM of iron sulfate (FeSO₄ or Fe) and 2.7 mM of fosetyl-aluminum (Fos Al), used alone (I) or combined by 2 (II), 3 (III), or 4 (IV).

FIG. 11 is a diagram showing the effect of combining cysteine, salicylic acid, iron sulfate and fosetyl-aluminum on mycelial growth in mm of Phaeomoniella chlamydospora at 18 days (A) and Phaeoacremonium aleophilum at 12 days (B) in liquid medium (YNB, glucose 50 mM, glutamine 40 mM, HEPES 10 mM, pH 4.2). More particularly, the different conditions of incubation are 5 mM of cysteine (Cys), 0.5 mM of salicylic acid (SA), 5 mM of iron sulfate (FeSO₄ or Fe) and 2.7 mM of fosetyl-aluminum (Fos Al or Fos), used alone (I) or combined by 2 (II), 3 (III), or 4 (IV).

FIG. 12 is a diagram showing the effect of combining cysteine, salicylic acid, iron sulfate and fosetyl-aluminum on the germination of spores of Phaeomoniella chlamydospora (A) and Phaeoacremonium aleophilum (B) in liquid medium (YNB, glucose 50 mM, glutamine 40 mM, HEPES 10 mM, pH 4.2) after 5 days, observed as the change in OD at 595 nm. More particularly, the different conditions of incubation are 5 mM of cysteine (Cys), 0.5 mM of salicylic acid (SA), 5 mM of iron sulfate (FeSO₄ or Fe) and 2.7 mM of fosetyl-aluminum (Fos Al or Fos), used alone (I) or combined by 2 (II), 3 (III), or 4 (IV).

FIG. 13 shows a curve of reversibility of mycelial growth in mm of Phaeomoniella chlamydospora (A, B and C) and of Phaeoacremonium aleophilum (A′ and B′) treated with different substances of the invention for 8 (A, A′), 15 (B, B′) and 21 (C) days and after passage on a nutrient medium without antifungal substances (YNB, glucose 50 mM, glutamine 40 mM, HEPES 10 mM, pH 4.2). More particularly, the different conditions of incubation are 5 mM of cysteine (Cys), 0.5 mM of salicylic acid (SA), 5 mM of iron sulfate (FeSO₄ or Fe) and 2.7 mM of fosetyl-aluminum (Fos Al or Fos), combined by 2 (II), 3 (III), or 4 (IV).

FIG. 14 is a diagram showing mycelial growth in mm of different strains of Phaeomoniella chlamydospora at 18 days (A) and of Phaeoacremonium aleophilum at 12 days (B) as a function of the presence of 5 mM of cysteine (Cys), 0.5 mM of salicylic acid (SA), 5 mM of iron sulfate (FeSO₄) and 2.7 mM of fosetyl-aluminum (Fos Al) on a solid nutrient medium (YNB, glucose 50 mM, glutamine 40 mM, HEPES 10 mM, pH 4.2).

FIG. 15 shows photographs of grapevine leaves two weeks after foliar treatment with different compositions of the invention on cuttings of Cabernet Sauvignon (A and B) and after four treatments, carried out with an interval of 14 days, on cuttings of Ugni blanc (C, D, E, F). More particularly, this diagram provides verification that the invention is harmless to the grapevine. A and C: untreated cuttings, D: treatment with cysteine (5 mM), salicylic acid (0.5 mM) and a wetting agent (Etaldyne 95, Fertiligène), E: treatment with iron sulfate (5 mM), fosetyl-aluminum (2.7 mM) and a wetting agent (Etaldyne 95, Fertiligène), F: treatment with cysteine (5 mM), salicylic acid (0.5 mM), iron sulfate (5 mM), fosetyl-aluminum (2.7 mM) and a wetting agent (Etaldyne 95, Fertiligène).

FIG. 16 shows blots of shoots from cuttings inoculated with a pathogen (Phaeomoniella chlamydospora) obtained 14 days after 1, 2, 3 or 4 treatments of said cuttings in the presence of different compositions of the invention. More particularly, the blots are developed with anti-Phaeomoniella chlamydospora antibodies. A: cuttings not inoculated, B: untreated cuttings, C: cuttings treated with salicylic acid (0.5 mM), cysteine (5 mM) and a wetting agent (Etaldyne 95, Fertiligène), D: cuttings treated with iron sulfate (5 mM), fosetyl-aluminum (2.7 mM) and a wetting agent (Etaldyne 95, Fertiligène), E: cuttings treated with iron sulfate (5 mM), fosetyl-aluminum (2.7 mM), salicylic acid (0.5 mM), cysteine (5 mM) and a wetting agent (Etaldyne 95, Fertiligène), +: positive control corresponding to 5 ng of proteins (F2) of Phaeomoniella chlamydospora and arranged for each development.

FIG. 17 shows blots of shoots from cuttings inoculated with a pathogen (Phaeoacremonium aleophilum) obtained 14 days after 2 or 4 treatments of said cuttings in the presence of different compositions of the invention. B: untreated cutting, C: cuttings treated with salicylic acid (0.5 mM), cysteine (5 mM) and a wetting agent (Etaldyne 95, Fertiligène), D: cuttings treated with iron sulfate (5 mM), fosetyl-aluminum (2.7 mM) and a wetting agent (Etaldyne 95, Fertiligène), E: cuttings treated with iron sulfate (5 mM), fosetyl-aluminum (2.7 mM), salicylic acid (0.5 mM), and cysteine (5 mM) and a wetting agent (Etaldyne 95, Fertiligène). +: positive control corresponding to 5 ng of proteins (F2) of Phaeoacremonium aleophilum and arranged for each development.

### EXAMPLES

In the following examples, the various measurements or experiments were performed according to the protocols described below.

### Biological Material and Culture Conditions

### Fungal Material

The strains of Phaeomoniella chlamydospora W. Gams, Crous and Phaeoacremonium aleophilum W. Gams, Crous, M. J. Wingfield, L. Mugnaï used were isolated and referenced in the context of the European project “Control of Esca and respect for the environment”. They were supplied by P. Larignon (ITV, Nimes) and J-P. Péros (INRA, Montpellier). Among the various strains, two were mainly used in our research: PC-PC 37 and PA-PC 24. These strains were isolated at the Fougerat foundation in the Graves district (16), from vine plants cv. Ugni blanc with esca. Table 1 gives the references of the strains used together with the district and grape variety on which they were isolated.

TABLE 1
Reference and origin of the various strains used
(Borie et al., 2002 (Ref 49))

| | Reference | | |
|---|---|---|---|
| | of the | | Grape |
| | strain | District | variety |
| Phaeomoniella | PC-PC 37 | Graves (16) | Ugni blanc |
| chlamydospora | PC-PC 3 | Les touches de | Ugni blanc |
| | | Périgny (17) | |
| | PC-PC 21 | Pouillac (17) | Ugni blanc |
| | PC-PC 32 | Saint-Preuil (16) | Ugni blanc |
| Phaeoacremonium | PA-PC 24 | Graves (16) | Ugni blanc |
| aleophilum | PA-PC 6 | Pérignac (16) | Ugni blanc |
| | PA-PC 20 | Saint-Preuil (16) | Ugni blanc |
| | PA-AQ 30 | Naujan et Postiac | Cabernet |
| | | (33) | Sauvignon |

Other fungi were also used in order to test the specificity of the antibodies: Alternaria sp., Botryosphaeria obtusa, Neofusicoccum parvum, Botrytis cinerea, Cladosporium sp., Cylindrocarpon destructans, Epicoccum sp., Eutypa lata, Fusarium sp., Paecilomyces sp., Penicillium sp., Pestalotia sp., Phoma sp., Phomopsis viticola, Pullularia sp., Trichoderma atroviride, Trichoderma harzianum and Verticillium chlamydosporum. The strains were identified and supplied by P. Larignon (I.F.V. Pole Rhone-Méditerranée).

### In-Vitro Culture Conditions of the Fungi

### Composition of the Basic Nutrient Medium

The fungi were grown on a completely synthetic medium composed of YNB (Yeast Nitrogen Base without amino acid and ammonium sulfate; DIFCO™ 233520) at 1.7 g/L, glucose at 50 mM (Sigma G5767) and glutamine at 40 mM (Sigma P0380). The pH was adjusted to 5.5 or to 4.2 for the testing of substances, and the medium is autoclaved for 15 min at 110° C.

### Solid Medium

The above medium was solidified with agar at 20 g/L (Sigma A1296). The strains were cultivated in a Petri dish with a diameter of 9 cm in the dark and at 25° C., the mean temperature favorable to the development of Phaeomoniella chlamydospora and Phaeoacremonium aleophilum. The strains were stored in the form of mycelial disks in sterile water in the dark at 4° C.

### Liquid Medium

The cultures in liquid medium were conducted in a conical flask containing 300 mL of the medium defined above, inoculated with three agar disks with a diameter of 1 cm on which the inoculum had developed.

### Test of Biological Activity

The tests with the different substances in solid medium (nitrogen-containing sources, carbon-containing sources and antifungal substances) were conducted in 6-well dishes with a diameter of 35 mm. The medium was buffered to pH 4.2 with HEPES 10 mM for the antifungal substances. The molecules to be tested were added before solidification of the medium. The medium was inoculated with a mycelial disk with a diameter of 4 mm from a parent culture in solid medium.

The tests on the effect of the antifungal substances on germination of spores were performed in a 96-well plate. The basic nutrient medium (Yeast Nitrogen Base, YNB), glucose 50 mM, glutamine 40 mM, HEPES 10 mM pH 4.2) is autoclaved for 15 min at 110° C. The different test compounds were added to the cooled medium. 200 μL of the test medium is deposited per well and is seeded with 50 000 spores. The microplates were stirred (160 rpm) at 22° C. in the dark. The absorbance was measured at 595 nm every two or three days using a microplate reader (Sunrise reader, Tecau). Before reading the absorbance, the plate was agitated for 5 s in order to homogenize the content of the wells.

### Measurement of the Growth Parameters of the Fungi

### In Solid Medium

The diameter of development of the fungus was measured using a graduated rule every other day for a month.

### In Liquid Medium

Three parameters were monitored during development of the fungi in liquid medium: dry mass of mycelium, pH of the culture medium and concentration of proteins secreted in the medium.

At the chosen time point, the liquid culture medium was centrifuged for 30 min at 20000×g at 4° C. to obtain a pellet of the mycelium and spores. The pellet obtained after centrifugation was dried in a stove at 60° C. for 24 h in order to determine the dry mass of the fungus. The supernatant was recovered and filtered on a filter with pore diameter of 0.22 μm (Whatman) for complete removal of the spores and the remaining mycelium. The pH of the supernatant was then measured using a pH-meter (pH 526, WTW). The concentration of proteins was measured by the Bearden technique (1978) (Ref 50). This technique consists of adding 100 μL of Triton X-100 at 0.1% (w/v) to x μL containing the proteins to be determined; x corresponds to 100 μL for determining the proteins contained in the culture medium of the fungi, 10 μL for determining the proteins of fraction F2. After incubation for 10 min, the volume is made up to 1 mL with milliQ water. 1 mL of Bearden reaction mixture is added. The absorbance is read at 595 nm after a waiting time of 10 min. The scale is constructed using bovine serum albumin (BSA).

### Culture Conditions of the Plant Material

The vines Vitis vinifera L. were of Ugni blanc (grape variety mainly used for the production of brandy since it represents 95% of the stock of vines of white varieties) and of Cabernet Sauvignon (black grape variety).

The plants were obtained by propagation by cuttings from shoots taken in the vineyard. For this, a cutting was taken, formed of two nodes separated by an internode. The bottom bud was removed with secateurs. The cutting thus obtained was put in a pot containing compost with added pozzuolana and was watered with water every three days. When the roots and leaves had developed sufficiently (4 leaves), the cuttings were then watered with a nutrient solution composed of potassium nitrate, monoammonium phosphate, monopotassium phosphate, magnesium sulfate, calcium nitrate, trace elements (B, Cu, Mn, Mo, Zn) and Sequestrene (registered trademark) (Syngenta). The plants were illuminated for 16 h per day mainly with natural light and sodium vapor lamps (Philips SON-T, 423 W) when the amount of luminous radiation was insufficient. The mean temperature was 22° C.±2° C. and the humidity was 70%±10%.

### Inoculation of the Cuttings

The cuttings were inoculated selectively, in a cavity with a depth of 1 cm made in the apical portion, with an agar disk with a diameter of 4 mm on which mycelia of Phaeomoniella chlamydospora (strain PC-PC37) or Phaeoacremonium aleophilum (strain PA-PC 24) have developed. Hydrophilic cotton was then placed on the agar disk and the whole was then wrapped in Parafilm and put in the soil.

### Treatment on Cuttings

The cuttings were treated by foliar spraying until they were dripping. The molecules tested were L-cysteine (Sigma), salicylic acid (Sigma), iron sulfate FeSO₄ heptahydrate (7H₂O) (Sigma) and fosetyl-aluminum (Aliette 80, KB jardin). A wetting agent (Etaldyne 95, alkylphenoloxyethylene, Fertiligène) was used at a concentration of 0.5 mL/L in order to optimize the area of contact between the composition and the leaf. The composition was sprayed on the plant at pH 4.5.

### Plants in the Vineyard

The plants used in natural conditions were from a plot of Ugni blanc planted in 1974 situated in Grande Champagne. The vines were trained flat using the Double Guyot system. The rows were 3 m apart and the plants were 1.3 m apart. The density was 2564 plants per hectare.

### Biochemical Methods

### Synthesis of the Antibodies

Two syntheses of antibodies were carried out: one directed against the proteins secreted by Phaeomoniella chlamydospora and the other against the proteins secreted by Phaeoacremonium aleophilum. Two rabbits were immunized for each synthesis of antibodies. The proteins secreted in the culture medium were lyophilized and suspended in milliQ water and then the sample was passed over Sephadex G25 resin (PD 10, GE Healthcare) in order to remove the salts contained in the nutrient medium. The fraction containing the proteins was lyophilized again and then suspended in PBS (phosphate buffer saline) (NaH₂PO₄ 4.4 mM, Na₂HPO₄ 16 mM, NaCl 300 mM, pH 7.4). The proteins were assayed by the Bearden technique. An amount of 1 mg of proteins to be injected per rabbit was required for carrying out the immunization.

Synthesis of the antibodies was entrusted to the company Agrobio (La Ferté Saint Aubin). The protocol for obtaining the antibodies takes 77 days. Four injections of antigens of 250 pg of proteins per rabbit are performed. Samples are taken at D49, at D68 and at D77 (corresponding to the final sampling).

The antibodies obtained in the final sampling were then purified by affinity chromatography on proteins A. Proteins A have the property of interacting specifically with the Fc portion of mammalian immunoglobulins.

### Hybridization of the Antibodies—Dot Blotting

This technique was used in order to detect proteins circulating in the plant by means of an antibody directed specifically against these proteins.

A blot of a shoot was obtained immediately after cutting, by applying the cut zone in contact with the membrane (Hybond™-ECL™, GE Healthcare) for 10 seconds. The proteins were fixed by leaving the membrane to dry for 30 min at room temperature. The membrane was then rinsed for 5 min in PBS 20 mM pH 7.4 with addition of Tween 20 at 0.2% (v/v) and then it was incubated overnight at 4° C. in saturation buffer (PBS 20 mM pH 7.4; milk proteins 3%; Tween 20 0.2%) in order to block the nonspecific sites. The rest of the protocol (hybridization of the antibodies and detection) was roughly identical to that of Western blotting described above. The membrane was incubated for 120 minutes in contact with the primary antibody diluted in the saturation buffer at 1/250. It was rinsed with the saturation buffer three times, for ten minutes each time. The membrane was then incubated in the secondary antibody coupled to peroxidase, diluted to 1/2000 with the saturation buffer for 90 minutes. The membrane was rinsed for 10 minutes with the saturation buffer then twice for 10 minutes with PBS 20 mM pH 7.4 milk proteins 3% and finally twice for 5 minutes with PBS 20 mM pH 7.4.

### Detection

The antigen-antibody complexes formed are detected using a kit (kit ECL RPN 2106, GE Healthcare) containing the peroxidase substrate conjugated to the secondary antibody. The interaction between the substrate and the enzyme causes emission of light capable of exposing a photographic film (Hyperfilm, GE Healthcare). The film was then treated with a developer (Ilford Ilfotec LC 29) diluted to 1/10 then with a fixing agent (Ilford Rapid Fixer) diluted to 1/10.

### Example 1

### Testing of Compounds on Phaeomoniella chlamydospora and Phaeoacremonium aleophilum

### 1. Effect of Sulfur-Containing Substances

1.a. Effect of Cysteine

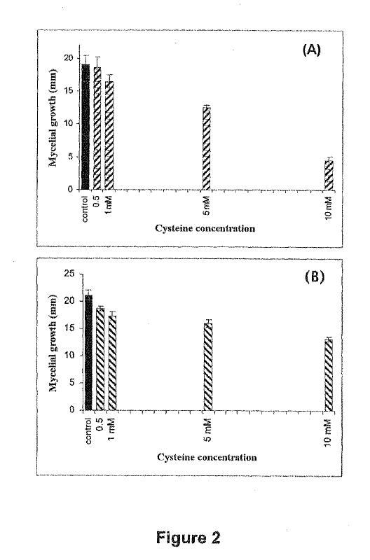

The inventors showed that cysteine slows the growth of Phaeomoniella chlamydospora and Phaeoacremonium aleophilum (FIG. 2). An identical observation has been made with other fungi such as Inonotus obliquus (Kahlos and Tikka, 1994 (Ref 22)), Alternaria sp. (Daigle and Cotty, 1991 (Ref 24)), Botrytis cinerea (Leroux, 1994 (Ref 51)) and in earlier work on Eutypa lata (Amborabé et al., 2005 (Ref 52); Octave et al., 2005 (Ref 23)).

The effect of different concentrations of cysteine on fungal growth of Phaeomoniella chlamydospora and Phaeoacremonium aleophilum was investigated. The results obtained are presented in Table 2 below and in FIG. 2.

TABLE 2
Table of results for cysteine

| | Phaeomoniella | Phaeoacremonium |
|---|---|---|
| conditions | chlamydospora | aleophilum |
| BNM | — | — |
| BNM + cysteine 0.5 mM | — | 11% inhibition of |
| | | growth |
| BNM + cysteine 1 mM | 13% inhibition | 18% inhibition |
| | of growth | |
| BNM + cysteine 5 mM | 34% inhibition | 24% inhibition |
| BNM + cysteine 10 mM | 80% inhibition | 37% inhibition |

—: no inhibition;
BNM: basic nutrient medium

These results demonstrate that mycelial growth of the two fungi is inhibited by cysteine at concentrations of 5 mM and 10 mM despite the presence of another nitrogen source (glutamine at 40 mM) in the nutrient medium. The slowing of the mycelial development is therefore connected with an inhibitory effect of cysteine and not with a problem of assimilation by the fungi.

As demonstrated here, cysteine alone only inhibits the development of Phaeomoniella chlamydospora and Phaeoacremonium aleophilum at relatively high concentrations. The sensitivity of the two fungi to cysteine is different.

1.b. Effect of Sulfates

Among the various nitrogen-containing sources slowing the development of the fungi, the inventors observed that ammonium sulfate (40 mM), used as the only nitrogen source, slows the growth of Phaeomoniella chlamydospora and Phaeoacremonium aleophilum. (results not shown).

In order to find out whether other sulfates possess the same property as ammonium sulfate, sulfates of potassium, of magnesium, of ferrous iron (Fe²⁺) and of copper were tested at a concentration of 40 mM, added to the basic nutrient medium (BNM).

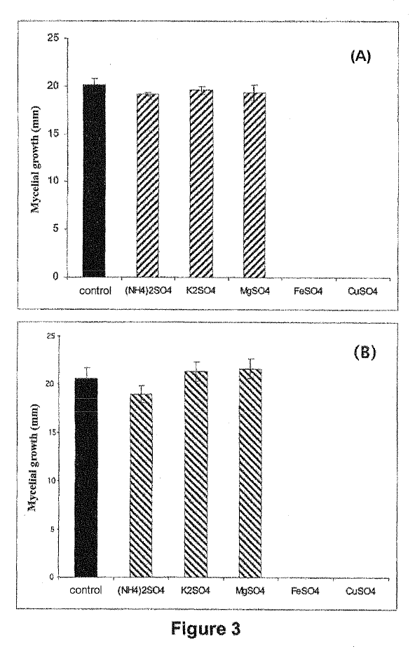

The results are presented in Table 3 below and in FIG. 3.

TABLE 3
Table of results for ammonium sulfate
((NH₄)₂SO₄), potassium sulfate (K₂SO₄) and magnesium
sulfate (MgSO₄)

| | Phaeomoniella | Phaeoacremonium |
|---|---|---|
| conditions | chlamydospora | aleophilum |
| BNM | — | — |
| BNM + (NH₄)₂SO₄ (40 mM) | — | — |
| BNM + K₂SO₄ (40 mM) | — | — |
| BNM + MgSO₄ (40 mM) | — | — |
| BNM + FeSO₄ (40 mM) | 100% inhibition | 100% inhibition |
| BNM + CuSO₄ (40 mM) | 100% inhibition | 100% inhibition |

—: no inhibition

Iron sulfate and copper sulfate completely inhibit mycelial growth of Phaeomoniella chlamydospora and Phaeoacremonium aleophilum at concentrations of 40 mM.

Copper sulfate is already widely used (Bordeaux mixture) in viticulture for combating various diseases (mildew, bacteriosis, bacterial necrosis).

However, extensive use of copper (one of the heavy metals) means that soils are becoming increasingly contaminated (Brown and Geoffrion, 2003 (Ref 53)). Moreover, copper sulfate cannot be mixed with fosetyl-aluminum. Accordingly, copper sulfate was not used.

1.c. Effect of Different Concentrations of Iron Sulfate (FeSO₄) on Mycelial Growth

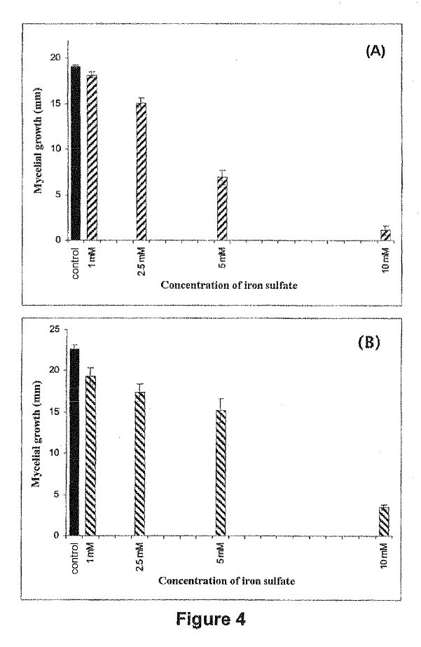

The results are presented in Table 4 and in FIGS. 4 (A and B).

TABLE 4
Results for different concentrations of iron
sulfate (FeSO₄)

| | Phaeomoniella | Phaeoacremonium |
|---|---|---|
| conditions | chlamydospora | aleophilum |
| BNM | — | — |
| BNM + FeSO₄(1 mM) | 4% inhibition | 15% inhibition |
| BNM + FeSO₄(2.5 mM) | 21% inhibition | 23.5% inhibition |
| BNM + FeSO₄(5 mM) | 64% inhibition | 33% inhibition |
| BNM + FeSO₄(10 mM) | 95% inhibition | 85% inhibition |

As demonstrated above, iron sulfate inhibits the growth of Phaeomoniella chlamydospora and Phaeoacremonium aleophilum more strongly at concentrations of 5 mM and 10 mM.

Sulfur does not seem to play a role in the efficacy of the different sulfates since there is no inhibition of growth of the fungi in the presence of ammonium sulfate, potassium sulfate and magnesium sulfate. In order to find out whether the efficacy of the molecule is due to the iron, other molecules having iron in the ferrous form (Fe²⁺) were tested: iron chloride (FeCl₂) and iron acetate (Fe(CH₃CO₂)₂) at concentrations of 5, 10 and 20 mM.

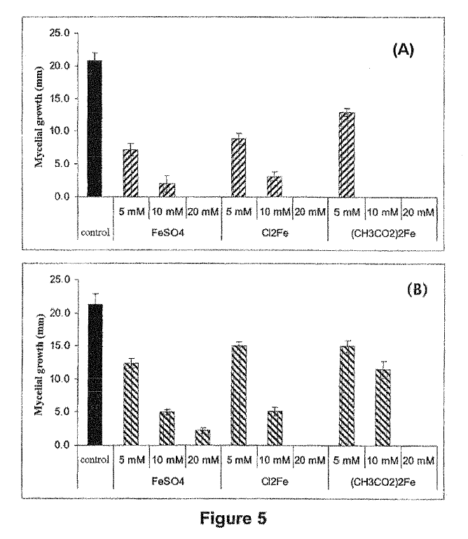

FIG. 5 A shows that there is dose-dependent inhibition of the growth of Phaeomoniella chlamydospora in the presence of iron sulfate, chloride and acetate. The inhibition caused by iron chloride is comparable to that obtained with iron sulfate whatever concentration is applied. The inhibition due to iron acetate is slightly reduced at 5 mM. In fact, it is 40% whereas that obtained with iron sulfate is 65%. At a concentration of 10 mM, fungal development is completely inhibited with iron acetate, which is not the case with iron sulfate and iron chloride. At 20 mM, growth of Phaeomoniella chlamydospora is completely inhibited no matter which ferrous molecule is tested.

FIG. 5 B shows that iron sulfate, chloride and acetate also cause dose-dependent inhibition of the development of Phaeoacremonium aleophilum. At 5 mM, growth of Phaeoacremonium aleophilum is more inhibited with iron sulfate than with iron chloride and acetate. At a concentration of 10 mM, the inhibition caused by iron chloride and sulfate is 75%. In contrast, the inhibition observed with iron acetate is less, since it reaches 45%. At a concentration of 20 mM, fungal development is completely inhibited with iron chloride and acetate. Phaeoacremonium aleophilum shows slight development in the medium containing iron sulfate.

As demonstrated above, the experiments conducted with different ferrous salts show that the efficacy of the molecule can therefore be attributed to the iron atom since all the ferrous molecules tested possess the same capacity for inhibiting the mycelial development of Phaeomoniella chlamydospora and Phaeoacremonium aleophilum.

### 2. Effect of Salicylic Acid

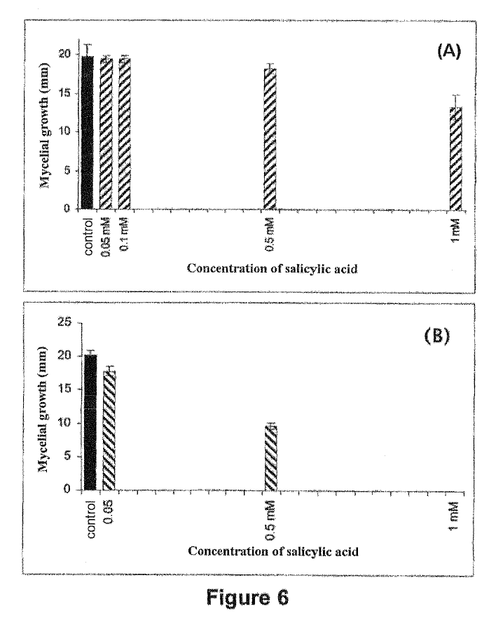

The results presented in FIG. 6 A show that salicylic acid does not inhibit the fungal development of Phaeomoniella chlamydospora at concentrations of 0.05 mM and 0.1 mM. At 0.5 mM, growth was inhibited by 10%, and at 1 mM by 28%.

Salicylic acid therefore has little effect on the mycelial growth of Phaeomoniella chlamydospora. Higher concentrations of salicylic acid were not tested, as problems of phytotoxicity may be observed at high concentrations.

FIG. 6 B shows that the development of Phaeoacremonium aleophilum is slightly inhibited at 0.05 mM. At 0.5 mM, growth was inhibited by 50%, and at 1 mM it is inhibited completely.

As demonstrated in this experiment, salicylic acid alone inhibits the development of Phaeomoniella chlamydospora slightly, and that of Phaeoacremonium aleophilum more strongly.

### 3. Effect of Fosetyl-Aluminum

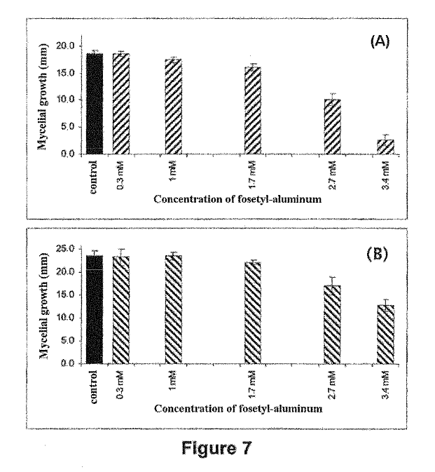

Various concentrations of fosetyl-aluminum were tested on the growth of Phaeomoniella chlamydospora and Phaeoacremonium aleophilum (FIG. 7).

The results presented in FIG. 7 A show that fosetyl-aluminum has no effect on the growth of Phaeomoniella chlamydospora at 0.3 mM. The mycelial development of Phaeomoniella chlamydospora is slightly inhibited at 1 mM (6%) and 1.7 mM (14%). There is greater inhibition at higher concentrations: it reaches 46% at 2.7 mM and 86% at 3.4 mM.

FIG. 7 B shows that fosetyl-aluminum has no effect at 0.3 mM and 1 mM on the growth of Phaeoacremonium aleophilum. A slight inhibition of the order of 6% is observed at a concentration of 1.7 mM. At higher concentrations, growth is inhibited by 30% at 2.7 mM and 45% at 3.4 mM.

As demonstrated above, fosetyl-aluminum alone inhibits the mycelial growth of Phaeomoniella chlamydospora and, to a slighter extent, that of Phaeoacremonium aleophilum. The sensitivity of Phaeoacremonium aleophilum to fosetyl-aluminum is therefore less than that of Phaeomoniella chlamydospora.

### Example 2

### Test of the Fungicidal Activity of Examples of the Composition of the Invention on Phaeomoniella chlamydospora and Phaeoacremonium aleophilum

In this example, for each molecule, the concentration used is that for which growth was inhibited by about 50%. Then the molecules were combined with one another in twos, then in threes, and then all together.

An analysis of the synergy of the mixture of the different molecules was performed. This analysis consists of comparing the efficacy of the mixture observed experimentally (E′) with the calculated theoretical efficacy (5) using Colby's formula (1967) (Ref 54), when the efficacy of each of the products is known.

E=(x+y)−(x·y)/100

E: percentage of theoretical efficacy of the combination of the 1st product and of the 2nd product

x: percentage efficacy of the 1st product

y: percentage efficacy of the 2nd product

When there is synergy of the products, the experimental efficacy (E′) of the mixture is greater than the calculated theoretical efficacy (E).

### 1. Cysteine/Salicylic Acid Combination

The inhibition was measured on a culture in solid medium. The medium and the culture conditions are described in the preceding section.

Cysteine, at a concentration of 5 mM, and salicylic acid, at different concentrations in the range from 0.05 mM to 1 mM, were tested alone or in combination in order to investigate their effects on mycelial growth.

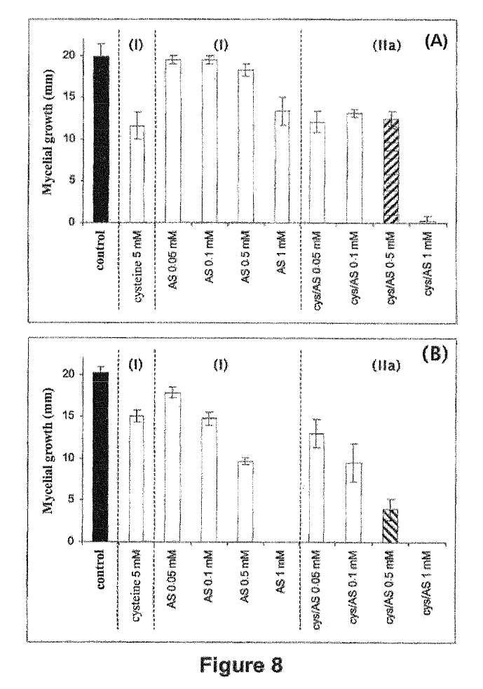

FIG. 8 A shows that the growth of Phaeomoniella chlamydospora is inhibited by 98% (E′) in the presence of the cysteine/salicylic acid mixture 1 mM, which is greater than the single effect induced by each compound and the addition of the effects produced by each compound separately. Calculation by Colby's formula (E=60%) shows that it is a synergistic effect.

Moreover, for Phaeoacremonium aleophilum (FIG. 8 B), the combination of the two molecules cysteine/salicylic acid makes it possible to reduce mycelial growth. This effect is in each case due to a synergistic effect of the molecules (E′=35>E=34 for cysteine/salicylic acid 0.05 mM; E′=52>E=45 for cysteine/salicylic acid 0.1 mM; E′=80%>E=64% for cysteine/salicylic acid 0.5 mM; E′=E=100 for cysteine/salicylic acid 1 mM).

The composition comprising cysteine and salicylic acid inhibits the growth of the pathogens and displays a synergistic effect.

### 2. Composition Comprising Iron Sulfate, Cysteine and Salicylic Acid

2.a. Cysteine/Iron Sulfate:

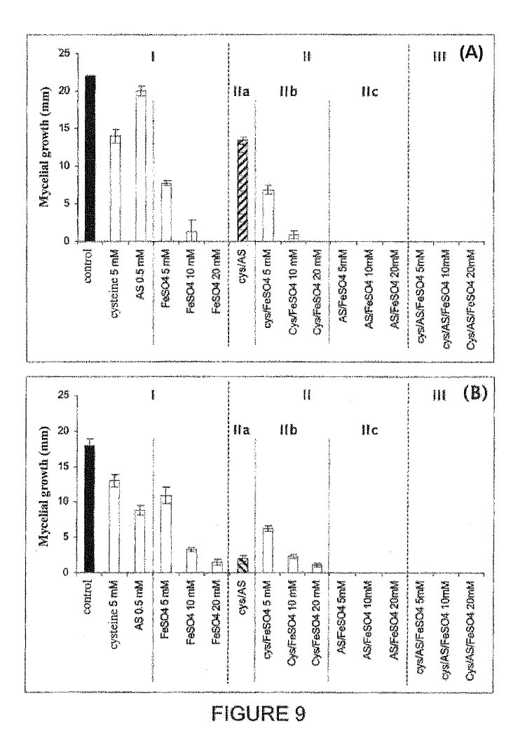

The results presented in FIG. 9 show that the combination of cysteine and iron sulfate at 5, 10 and 20 mM makes it possible to reduce the growth of Phaeomoniella chlamydospora and of Phaeoacremonium aleophilum.

FIG. 9 B shows that the inhibition of the growth of Phaeoacremonium aleophilum due to the combination of cysteine and iron sulfate (at the different concentrations tested) is greater than the inhibition caused by the compounds alone. A synergistic effect is observed in each case since the experimental efficacy (65%, 87%, 94%) is greater than the theoretical efficacy (55%, 86%, 93%) (FIG. 9 B (IIb)).

2.b. Salicylic Acid/Iron Sulfate:

The composition comprising salicylic acid at 0.5 mM with iron sulfate at 5, 10 and 20 mM completely inhibits the fungal development of the two fungi whatever the concentration of iron sulfate. A synergistic effect was observed for each concentration with both fungi.

For Phaeomoniella chlamydospora, the experimental efficacy E′ (100%) is greater than the theoretical efficacy E, which is 67% for the combination salicylic acid at 0.5 mM/iron sulfate 5 mM, 94% for the combination salicylic acid at 0.5 mM/iron sulfate 10 mM and 100% for the combination salicylic acid/iron sulfate 20 mM ((FIG. 9 A (IIc)).

For Phaeoacremonium aleophilum, the experimental efficacy E′ (100%) is greater than the theoretical efficacies E which are 69%, 91% and 95% respectively for each of the combinations with an increasing concentration of iron sulfate (FIG. 9 B (IIc)).

This example clearly demonstrates that the composition of the invention is an antifungal composition displaying a synergistic effect with results that are far better than those observed with the compositions of the prior art.

2.c. Iron Sulfate/Cysteine/Salicylic Acid:

The experimental results of this example are presented in FIGS. 9 A and 9 B and demonstrate that the mixture of the three molecules at the concentrations investigated (III) completely inhibits the mycelial growth of Phaeomoniella chlamydospora and Phaeoacremonium aleophilum whatever the concentration of iron sulfate added.

These results are good confirmation of the synergistic effect of the composition of the invention.

### 3. Composition Comprising Fosetyl-Aluminum, Cysteine, Salicylic Acid, Iron(IV) Sulfate

The compounds tested comprise fosetyl-aluminum at 2.7 mM, cysteine 5 mM, salicylic acid 0.5 mM and iron sulfate 5 mM. The molecules tested were combined two, three or four at a time.

a) Inhibition of Fungal Growth with Compositions Comprising Two or Three Compounds

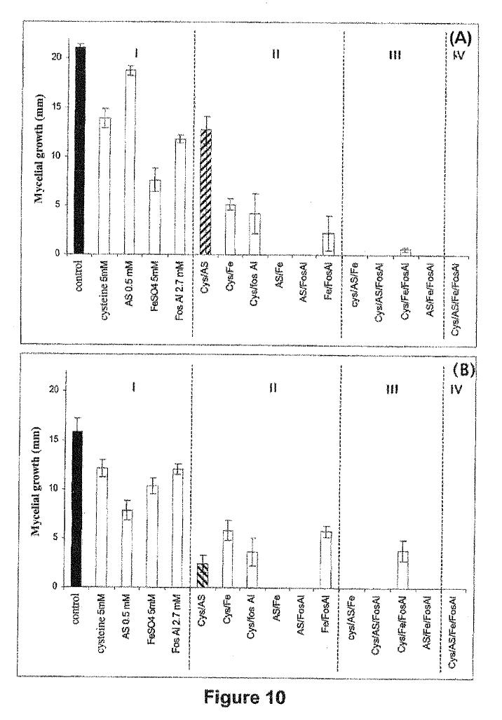

Table 5 below and FIG. 10 A (II and III) and B (II and III) present the experimental results obtained on fungi cultivated on solid medium with the various combinations.

TABLE 5
Table of results for different combinations

| | Phaeomoniella | Phaeoacremonium | |
|---|---|---|---|
| Composition | chlamydospora | aleophilum | Synergy |
| BNM | — | — | |
| Cysteine- | 80% inhibition | 75% inhibition | Yes |
| fosetyl | E′ > E (63%) | (E′ > E (42%)) | |
| Iron | 90% inhibition | 65% inhibition | Yes |
| sulfate/fosetyl- | (E′ > E (79%)) | (E′ > E (50%)). | |
| aluminum | | | |
| Salicylic | 100% inhibition | 100% inhibition | Yes |
| acid/fosetyl- | E′(100%) > E(50%) | (E′ > E (62%)) | |
| aluminum | | | |
| Cysteine/iron | 97% | 75% | Yes |
| sulfate/fosetyl | | | |
| Cysteine/ | 100% | 100% | Yes |
| salicylic acid/ | | | |
| fosetyl-aluminum | | | |
| Salicylic | 100% | 100% | Yes |
| acid/iron | | | |
| sulfate/fosetyl- | | | |
| aluminum | | | |

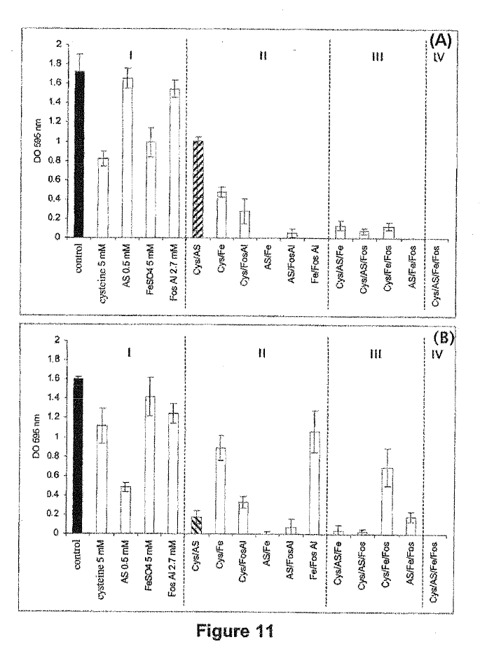

The experimental results obtained, presented in FIG. 11 A (II and III) and B (II and III), demonstrate complete inhibition of the growth of Phaeomoniella chlamydospora and of Phaeoacremonium aleophilum in liquid medium with the compositions comprising salicylic acid and iron sulfate.

Certain combinations of molecules do not completely inhibit the fungal development of Phaeoacremonium aleophilum in liquid medium (FIG. 11 B (II and III)). Residual growth is observed for the mixtures salicylic acid/fosetyl-aluminum (3.5%), cysteine/salicylic acid/iron sulfate (2%), cysteine/salicylic acid/fosetyl-aluminum (0.5%), salicylic acid/iron sulfate/fosetyl-aluminum (10%).

The culture conditions of the fungus can therefore alter the efficacy of the treatment applied with compositions comprising two or three compounds.

b) Inhibition of Fungal Growth with Compositions Comprising Four Compounds

As demonstrated in this experiment (FIG. 10 A and B (IV) and FIGS. 11 A and B (IV)), growth of Phaeomoniella chlamydospora and Phaeoacremonium aleophilum in liquid medium is completely inhibited in the presence of the mixture cysteine 5 mM/salicylic acid 0.5 mM/iron sulfate 5 mM/fosetyl-aluminum 2.7 mM in liquid and solid medium.

As demonstrated in this example, a composition according to the invention can inhibit the growth of pathogens.

### Example 3

### Effect of the Composition on the Germination of Spores

The different molecules used alone or mixed were tested in order to find out whether the composition has an effect on the germination of spores of Phaeomoniella chlamydospora and Phaeoacremonium aleophilum.

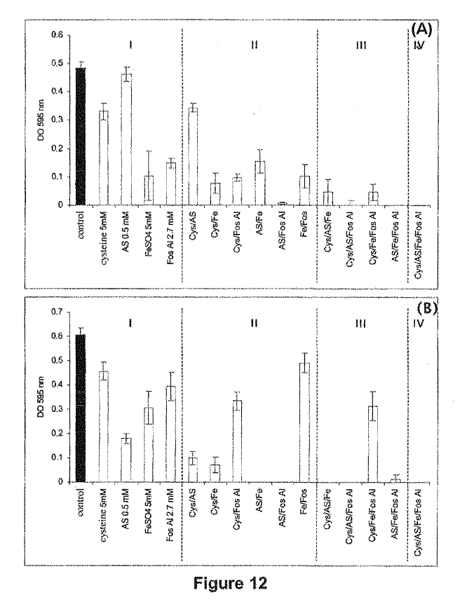

FIG. 12 A demonstrates that all the compositions tested have an inhibitory effect on germination.

More particularly, the mixtures salicylic acid/fosetyl-aluminum (II), cysteine/salicylic acid/iron sulfate (III), salicylic acid/iron sulfate/fosetyl-aluminum (III), cysteine/salicylic acid/iron sulfate/fosetyl-aluminum (IV) completely inhibit the germination of spores of Phaeomoniella chlamydospora. In contrast, it is not completely inhibited in the presence of the mixture salicylic acid/iron sulfate (II) whereas its growth is completely inhibited in solid and liquid media. The mixture salicylic acid/iron sulfate therefore seems in particular to have an effect on the growth of the mycelium and a smaller effect on the germination of spores. Similarly, germination of spores is not completely inhibited in the presence of cysteine/salicylic acid/iron sulfate (III) whereas the mycelium shows little development in solid medium in the same conditions.

FIG. 12 B shows that germination of spores of Phaeoacremonium aleophilum is completely inhibited in the presence of the mixture salicylic acid/iron sulfate, salicylic acid/fosetyl-aluminum (II), cysteine/salicylic acid/iron sulfate, cysteine/salicylic acid/fosetyl-aluminum (III), cysteine/salicylic acid/iron sulfate/fosetyl-aluminum (IV). Mycelial growth is completely inhibited with the same mixtures in solid medium and very strongly in liquid medium.

Several mixtures of molecules completely or partially inhibit the germination of spores of Phaeomoniella chlamydospora and Phaeoacremonium aleophilum.

These results further demonstrate that the composition of the invention used during the period of sporulation of the fungi might make it possible to prevent new contaminations by inhibiting sporulation.

### Example 4

### Measurement of the Fungistatic Effect or Fungicidal Effect of the Composition

In order to measure the fungicidal effect and/or fungistatic effect of the composition, mycelial implants used for seeding the nutrient medium containing the various molecules to be tested in solid medium were deposited on a nutrient medium without antifungal substances after 8, 15 and 21 days of contact with the antifungal substances according to the protocol described above.

Resumption of growth indicates that the mixture has a fungistatic effect whereas zero growth indicates that the treatment has a fungicidal effect.

The results also make it possible to determine the required contact time between the fungus and the treatment for the fungus to be killed and for the germination of conidiospores to be inhibited completely. This was measured from the growth of the fungus in the presence of different combinations then after passage on a nutrient medium lacking antifungal substances after 8, 15 or 21 days of treatment.

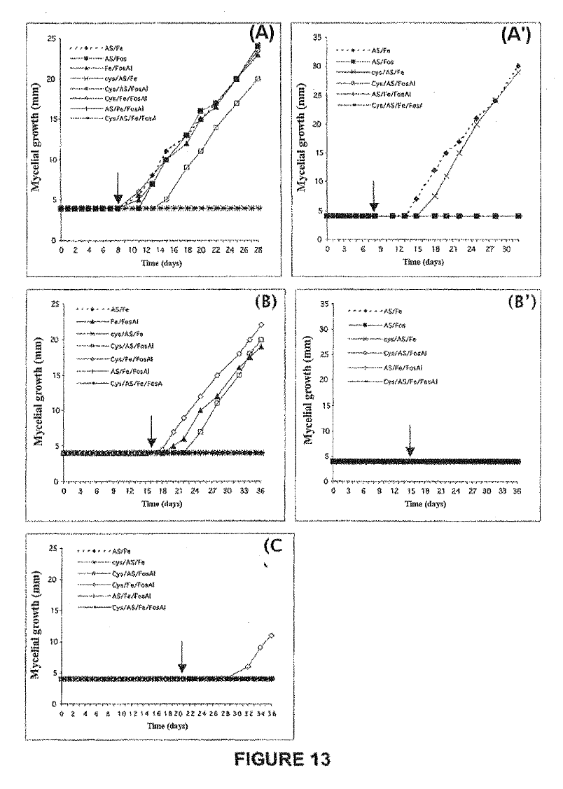

The results presented in FIG. 13 A, B and C and in Table 7 below show the fungicidal or fungistatic effect of the compositions.

After 8 days of contact (FIG. 13 A) with the composition: salicylic acid/iron sulfate, salicylic acid/fosetyl-aluminum, iron sulfate/fosetyl-aluminum, cysteine/salicylic acid/fosetyl-aluminum, cysteine/iron sulfate/fosetyl-aluminum, Phaeomoniella chlamydospora develops after passage on the medium without antifungal substances. These various combinations therefore have a fungistatic effect.

In the case of the combinations cysteine/salicylic acid/iron sulfate, salicylic acid/iron sulfate/fosetyl-aluminum and cysteine/salicylic acid/iron sulfate/fosetyl-aluminum, passage of the mycelial implants on a medium without antifungal substances does not reestablish growth of the fungus. These compositions therefore have a fungicidal effect.

After 15 days (FIG. 13 B), mycelial implants in contact with the combinations iron sulfate/fosetyl-aluminum, cysteine/salicylic acid/fosetyl-aluminum, cysteine/iron sulfate/fosetyl-aluminum develop 5, 7 and 3 days respectively after passage on a substance-free medium, which indicates that these combinations have a fungistatic effect. The mycelial implants in contact with the other mixtures (salicylic acid/iron sulfate, cysteine/salicylic acid/iron sulfate, salicylic acid/iron sulfate/fosetyl-aluminum, cysteine/salicylic acid/iron sulfate/fosetyl-aluminum) do not resume development. These compositions therefore have a fungicidal effect.

FIG. 13 C shows that only the mycelium of Phaeomoniella chlamydospora in contact for 21 days with the mixture cysteine/iron sulfate/fosetyl-aluminum starts growing again after passage on the medium without antifungal substances after a latency period of days. All the other combinations tested have a fungicidal effect after 21 days of contact.

FIGS. 13 A′ and B′ show the growth of Phaeoacremonium aleophilum after contact with different combinations for 8 and 15 days and then transfer to a medium lacking antifungal substances. After 8 days of contact, mycelial growth is completely inhibited in the presence of the following combinations: salicylic acid/fosetyl-aluminum, cysteine/salicylic acid/fosetyl-aluminum, salicylic acid/iron sulfate/fosetyl-aluminum, cysteine/salicylic acid/iron sulfate/fosetyl-aluminum. These mixtures have a fungicidal effect. In contrast, the inhibition of growth observed with the mixtures salicylic acid/iron sulfate and cysteine/salicylic acid/iron sulfate is only maintained for 5 and 7 days after passage on a medium lacking antifungal substances. After this time lapse, the fungus resumes normal growth, which indicates that these combinations have a fungistatic effect. After 15 days of treatment, development of Phaeoacremonium aleophilum in the presence of the various combinations is completely inhibited.

Some of the results are summarized in Table 6 below.

TABLE 6
Fungicidal or fungistatic effects of different mixtures
on the growth of Phaeomoniella chlamydospora and
Phaeoacremonium aleophilum after 8, 15 or 21 days of contact

| | Phaeomoniella chlamydospora | | | | Phaeoacremonium aleophilum | | |
|---|---|---|---|---|---|---|---|
| | 8 days | 15 days | 21 days | | 8 days | 15 days | |
| AS/FeSO₄ | + | − | − | fungicidal | + | − | fungicidal |
| AS/Fos Al | + | x | x | fungistatic | − | − | fungicidal |
| FeSO₄/Fos Al | + | + | x | fungistatic | x | x | |
| Cys/AS/FeSO₄ | − | − | − | fungicidal | + | − | fungicidal |
| Cys/AS/Fos Al | + | + | − | fungicidal | − | − | fungicidal |
| Cys/FeSO₄/Fos Al | + | + | + | fungistatic | − | − | fungicidal |
| AS/FeSO₄/Fos Al | − | − | − | fungicidal | − | − | fungicidal |
| cys/AS/FeSO₄/Fos Al | − | − | − | fungicidal | − | − | fungicidal |

Legend for Table 6:
+: mycelial growth
−: no mycelial growth
x: mixture not tested as the mycelium had already developed on the medium containing the various combinations.

### Example 5

### Effect of the Composition on Different Strains of Phaeomoniella chlamydospora and Phaeoacremonium aleophilum

The mixture was developed on a strain of Phaeomoniella chlamydospora (PC-PC 37) and a strain of Phaeoacremonium aleophilum (PA-PC 24).

The composition was tested on other strains of Phaeomoniella chlamydospora and Phaeoacremonium aleophilum in solid medium to make sure that it inhibits the growth of the other strains of fungi cultivated in vitro.

The strains and the conditions for carrying out this experiment are presented in the material and method section described above.

The various strains of Phaeomoniella chlamydospora tested were PC-PC 37, PC-PC 3, PC-PC 21, PC-PC 32.

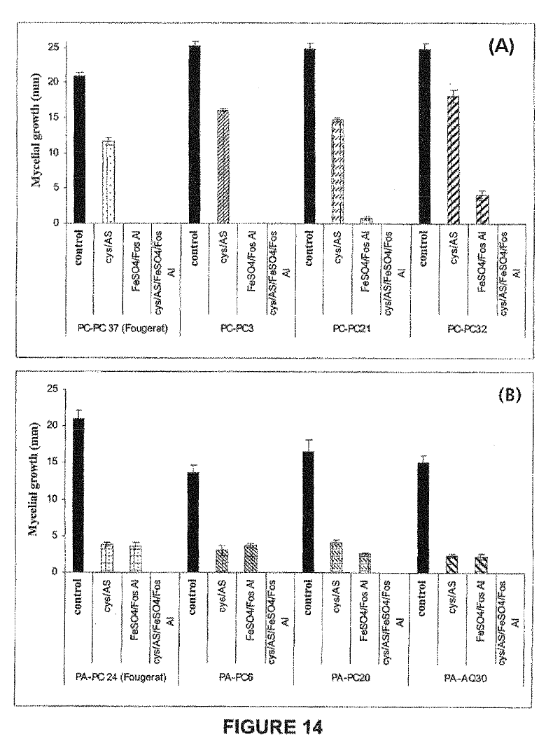

In the presence of the cysteine/salicylic acid mixture, inhibition of mycelial growth is 44% for PC-PC 37, 36% for PC-PC 3, 41% for PC-PC 21 and 27% for PC-PC 32. Treatment with the combination iron sulfate/fosetyl-aluminum completely inhibits development of the strains PC-PC 37 and PC-PC 3 whereas development of the strain PC-PC 21 is inhibited by 96% and that of PC-PC 32 by 83%. The combination of the four molecules completely inhibits mycelial growth of all the strains of Phaeomoniella chlamydospora (FIG. 14 A).

The various strains of Phaeoacremonium aleophilum tested were PA-PC 24, PA-PC6, PA-PC20 PA-AQ 30. As shown in FIG. 14 B, the growth of the strains is strongly inhibited with the combinations cysteine/salicylic acid and iron sulfate/fosetyl-aluminum and is completely inhibited with the mixture of the four molecules.

The results obtained demonstrate that the composition of the invention inhibits the growth of the fungus regardless of the strain tested.

### Example 6

### Verification of the Harmlessness of Compositions on Cuttings

Compositions were tested mixed two together (cysteine 5 mM/salicylic acid 0.5 mM and iron sulfate 5 mM/fosetyl-aluminum 2.7 mM) or four together on cuttings of Ugni blanc and on cuttings of Cabernet Sauvignon.

The cuttings and conditions for execution are identical to those described above.

A wetting agent (Etaldyne 95, Fertiligène) was added to the mixture, which was applied on the cuttings by foliar spraying.

No plant protection treatment was carried out in parallel with these treatments.

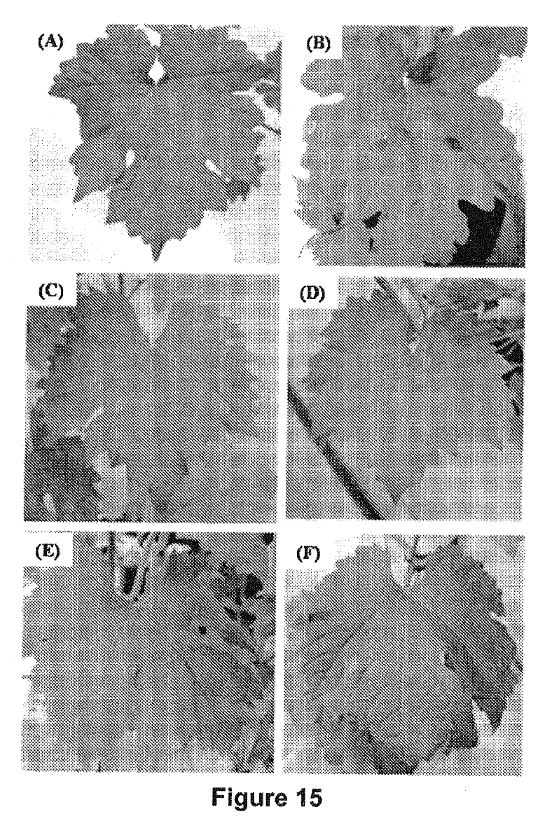

Observation of the cuttings was carried out two weeks after treatment for the cuttings of Cabernet Sauvignon (FIG. 15 B) and two weeks after four treatments, carried out at intervals of 14 days, for the cuttings of Ugni blanc (FIGS. 15 D, E, F).

Mixing of the four substances leads to slight synthesis of anthocyans (FIG. 15 B) in the oldest leaves of Cabernet Sauvignon. This synthesis of anthocyans is characteristic of activation of the plant's secondary metabolism and does not correspond to a phytotoxic effect.

As shown in FIG. 15, the cuttings of Ugni blanc have no sign of phytotoxicity whether for the treatments based on a mixture of two (FIGS. 15 D and 15 E) or four substances (FIG. 15 F).

The composition of the invention therefore makes it possible to inhibit mycelial growth without any adverse effect for the plant, in contrast to the compositions of the prior art.

### Example 7

### Verification of the Efficacy of Compositions on Cuttings with the Blot Transfer Technique and Antibodies Developed

The antibodies as well as the protocols of the procedure of this example are described in the methods section.

Four treatments were carried out on cuttings inoculated at an interval of 14 days.

The first treatment was carried out on cuttings that had been inoculated two-and-a-half months previously. The efficacy of the treatment was evaluated by blot transfer. The blots were performed 14 days after each treatment.

| 14 | 29 | 13 | 27 | 10 | 24 |
|---|---|---|---|---|---|
| April | June | July | July | August | August |
| Inoculation | 1st treatment | 1st sampling | 2nd sampling | 3rd sampling | 4th sampling |
| and putting the | | 2nd treatment | 3rd treatment | 4th treatment | |
| cuttings in | | | | | |
| the greenhouse | | | | | |

Three batches of cuttings were taken for each fungus:
a batch of cuttings not inoculated (64 cuttings),
a batch of cuttings inoculated but not treated (32 cuttings per fungus),
a batch of cuttings inoculated and treated with the mixture of two molecules (salicylic acid 0.5 mM/cysteine 5 mM or iron sulfate 5 mM/fosetyl-aluminum 2.7 mM) or of four molecules (60 cuttings for each fungus).

The antibodies and the protocol for incubation and detection of the results are identical to those described above.

1. Cuttings Inoculated with Phaeomoniella chlamydospora

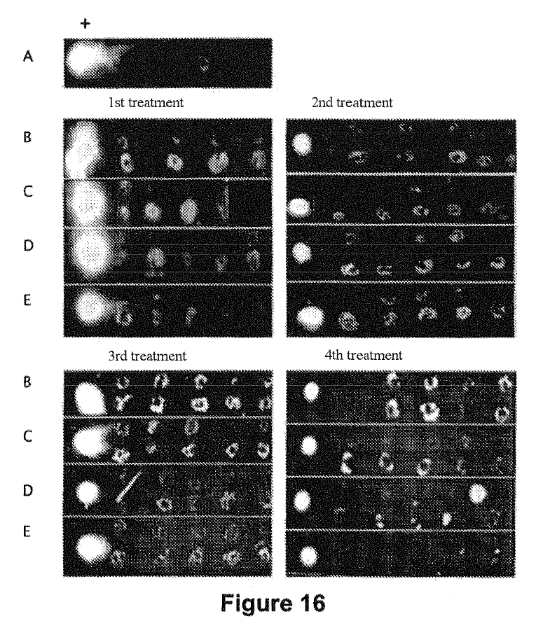

For each cutting, a blot was performed with the basal portion of the shoot and another with the apical portion 14 days after each treatment had been carried out (FIG. 16).

The signals detected correspond to the presence of proteins synthesized by the fungi and detected by means of antibodies specific to the proteins secreted.

### First Treatment:

Just one blot performed with an uninoculated cutting has a faint signal (FIG. 16 A). A strong signal is to be noted for all the blots of the shoots of the inoculated but untreated cuttings (FIG. 16 B). For the cuttings that were inoculated and treated, a signal is detected for all the blots of the shoot. However, the signal intensity is weaker for the iron sulfate/fosetyl-aluminum treatment (FIG. 16 D) and for the treatment combining the four molecules (FIG. 16 E).

### Second Treatment:

A signal was recorded for the untreated cuttings and for the treated cuttings, regardless of the treatment.

### Third Treatment:

The blots of the basal and apical portions of the shoots of the untreated cuttings have an increased signal. A signal is detected for all the blots of the treated cuttings (FIGS. 16 C, D and E). However, the signal is much weaker for the blots from cuttings treated with the iron sulfate/fosetyl-aluminum mixture (FIG. 16 D) and with the mixture of the four molecules, relative to the blots of the untreated cuttings (FIG. 16 E).

### Fourth Treatment:

A signal is still obtained with the cuttings treated with the salicylic acid/cysteine mixture. The signal for the blots from the cuttings treated with the iron sulfate/fosetyl-aluminum mixture is much weaker than for the untreated cuttings. A signal is no longer detected for 4 of the 5 cuttings treated with the mixture of the four molecules.

2. Cuttings Inoculated with Phaeoacremonium aleophilum

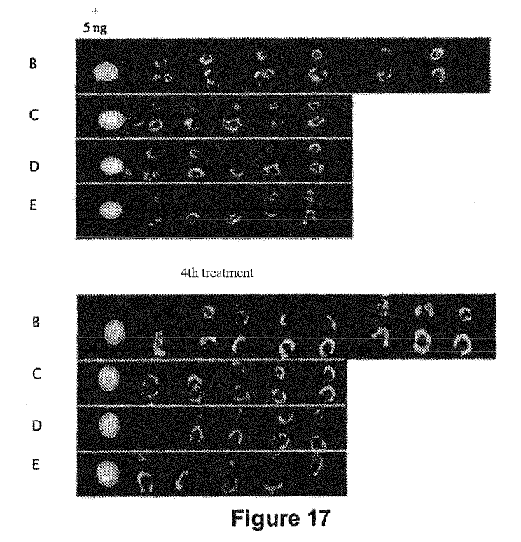

FIG. 17 presents the results obtained with a composition comprising two or four compounds after two or four treatments of cuttings inoculated with Phaeoacremonium aleophilum and makes it possible to compare the intensity of the signal observed with that of untreated inoculated cuttings.

### Second Treatment:

A signal is recorded for all the blots obtained from the basal portion and from the apical portion of the shoots of the untreated cuttings. The treatments with the combination of two molecules are unable to reduce the signal intensity. The signal obtained with the blots from the cuttings treated with the combination of four molecules (FIG. 17 E) is weaker than that obtained with the untreated cuttings (FIG. 17 B).

### Fourth Treatment:

After four treatments (FIG. 17 E), a signal is observed for all the cuttings inoculated with Phaeoacremonium aleophilum, whether or not they are treated. However, the signal intensity is much greater for the blots obtained from the untreated cuttings (FIG. 17 B) than with the treated cuttings (Figures C, D and E). The lowest signal intensity is that obtained with the treatments iron sulfate/fosetyl-aluminum (FIG. 17 D) and the mixture of the four molecules (FIG. 17 E).

Four treatments with the salicylic acid/cysteine/iron sulfate/fosetyl-aluminum mixture, allow that secretion of molecules by Phaeomoniella chlamydospora in planta is no longer detected. This effect is less marked for Phaeoacremonium aleophilum.

The signal intensity for the blots obtained from the cuttings treated with compositions comprising two or four compounds is much lower than for the untreated cuttings.

This, example therefore clearly demonstrates that a composition of the invention has an antifungal effect and notably can inhibit the secretion of proteins by the fungi in the plant.

### LIST OF REFERENCES

(Ref 1) Daire X., Poinssot B., Bentéjac M., Silué D., Pugin A., 2002—Stimulation des defenses de la vigne contre les pathogènes. Des resultats encourageants vis-à-vis du mildiou [Stimulation of the defenses of grapevine against pathogens. Encouraging results with respect to mildew]. Phytoma, la defense des végétaux, 548: 24-26.
(Ref 2) White R. F., 1979—Acetyl salicylic acid (aspirin) induces resistance to tobacco mosaic virus in tobacco. Virology, 99: 410-412.
(Ref 3) Van Loon L.C., 1983—The induction of pathogenesis related proteins by pathogens and specific chemicals. Neth. J. Plant Pathol., 89: 265-273.
(Ref 4) Malamy J., Carr J. P., Klessig D. F., Raskin I., 1990—Salicylic acid: a likely endogenous signal in the resistance response of tobacco to viral infection. Science, 250: 1002-1004.
(Ref 5) Métraux J. P., Signer H., Ryals J., Ward E., Wyss-Benz M., Gaudin J., Raschdorf K., Schmid E., Blum W., Inverardi B., 1990—Increase in salicylic acid on the onset of systemic acquired resistance in cucumber. Science, 250: 1004-1006.
(Ref 6) Kessmann H., Oostendorp M., Staub T., 1996—CGA 2455704: mode of action of a new plant activator. Brighton Crop Prot. Conf., Pests and diseases: 961-966.
(Ref 7) Amborabe B. E., Fleurat-Lessard P., Chollet J. F., Roblin G., 2002—Antifungal effects of salicylic acid and other derivatives towards Eutypa lata: structure-activity relationship. Plant Physiol. Biochem., 40: 1051-1060.
(Ref 8) Regnault-Roger C., 2006—Les substances naturelles d'origine végétale. Qu'elles soient biopesticides ou éliciteurs (SDN), quelles sont leurs perspectives dans la protection des cultures? [Natural substances of vegetable origin. Whether they are biopesticides or elicitors (SDN), what are their prospects in crop protection?]. Phytoma. La défense des végétaux, 591: 14-18.
(Ref 9) Rocher F., Chollet J. F., Jousse C., Bonnemain J.-L., 2006—Salicylic acid, an ambimobile molecule exhibiting a high ability to accumulate in the phloem. Plant Physiol., 141: 1684-1693.
(Ref 10) Rocher F., 2004—Lutte chimique centre les champignons pathogènes des plantes: évaluation de la systémie phloémienne de nouvelles molécules à effet fongicide et d'activateurs de reactions de défense [Chemical control of pathogenic fungi of plants: evaluation of the phloem systemics of new molecules with fungicidal effect and as activators of defense reactions]. Doctorate Thesis, University of Poitiers, 146 p.
(Ref 11) Dong X., 1998—SA, JA, ethylene, and disease resistance in plants. Current Opin. Plant Biol., 1: 316-323.
(Ref 12) Van Toor R. F., Jaspers M. V., Stewart A., 2001—Evaluation of acibenzolar-5-methyl for induction of resistance in Camellia flowers to Ciborinia camelliae infection. New Zealand Plant Protection, 54: 209-212.
(Ref 13) Ruess W., Mueller K., Krauf-Beiter G., Kunz W., Staub T., 1996—Plant activator CGA 245704: An innovative approach for disease control in cereals and tobacco. Proceedings of the Brighton Crop Protection Conference. Pests and diseases, 53-60.
(Ref 14) Ishii H., Tomita Y., Narusaka Y., Nishimura K., Ywamoto S., 1999—Induced resistance of acibenzolar-5-methyl (CGA 245704) to cucumber and japanese pear diseases. Eur. J. Plant Pathol., 105: 77-85.
(Ref 15) Leroux P., 2003—Modes d'action des produits phytosanitaires sur les organismes pathogénes des plantes [Modes of action of plant protection products on plant pathogens]. C. R. Biologies, 326: 9-21.
(Ref 16) Brisset M. N., Chartier R., Didelot F., Parisi L., Paulin J-P., Robert P., Tharaud M., Lemarquand A., Orain G., Toubon J-F., Brun L., Derridj S., Sauphanor B., 2005—Inducteurs de défenses naturelles des plantes [inducers of natural defenses of plants]. Phytoma. La défense des végétaux, 581: 20-24.
(Ref 17) Alabouvette C, Olivain C, Cordier C, Steinberg C, 2003—Méthodes alternatives de lutte contre les maladies des plantes. Prophylaxie, produits naturels, micro-organismes: progrès accomplis et à accomplir [Alternative methods of combating plant diseases. Prophylaxis, natural products, microorganisms: progress made and to be made]. Phytoma. La défense des végétaux, 566: 41-44.
(Ref 18) Conrath U., Pieterse C. M. J., Mauch-Mani B., 2002—Priming in plant-pathogen interaction. Trends Plant Sci., 7 (5): 210-216.
(Ref 19) Spiers A., Ward E. G., 2001—Injection treatment for control of plant diseases. In Patent Cooperation Treaty, Vol PCT WO 01/76355A1, New Zealand.
(Ref 20) Larignon P., Molot B., 2004—Les maladies du bois: expérimentations en cours et premiers résultats [Diseases of wood: experiments in progress and preliminary results]. Les entretiens viti-vinicoles Rhône-Méditerranée, 23-26.
(Ref 21) Williams J. S., Hall S. A., Hawkesford M. J., Beale M. H., Cooper R. M., 2002—Elemental sulphur and thiol accumulation in tomato and defense against a fungal vascular pathogen, Plant Physiol., 128: 150-159.
(Ref 22) Kahlos K., Tikka V. H., 1994—Antifungal activity of cysteine, its effect on C-21 oxygenated lanosterol derivatives and other lipids in Inonotus obliquus, in vitro. Appl. Microbiol. Blot., 42: 385-390.
(Ref 23) Octave S., Amborabé B. E., Luini E., Ferreira T., Fleurat Lessard P., Roblin G., 2005—Antifungal effects of cysteine towards Eutypa lata, a pathogen of vineyards. Plant Physiol. Bioch., 43: 1006-1013.
(Ref 24) Daigle D. J., Catty J. C., 1991—The influence of cysteine, cysteine analogs and other amino acids on spore germination of Alternaria species. Can. J. Bot., 69: 2353-2356.
(Ref 25) Granado J., Felix G., Boller T., 1995—Perception of fungal sterols in plants. Subnanomolar concentrations of ergosterol elicit extracellular alkalinisation in tomato cells. Plant Physiol., 107: 485-490.
(Ref 26) Amborabé B. E., 2000—Recherche sur l'Eutypiose: étude de relations Vigne-Eutypa lata et lutte antifongique par des molecules naturelles [Research into eutypiosis: study of Grapevine-Eutypa lata relations and control of fungi with natural molecules]. Doctorate thesis, University of Poitiers, 135 p.
(Ref 27) Amborabé B. E., Rossard S., Pérault J. M., Roblin G., 2003—Specific perception of ergosterol by plant cells. C. R. Biologies, 326: 363-370.
(Ref 28) Luini E., 2003—Etude de la transduction du signal impliquée dans la réponse de la cellule végétale à l'ergosterol [Study of transduction of the signal implicated in the response of the plant cell to ergosterol]. DEA report, University of Poitiers. 30 p.
(Ref 29) Rossard S., 2003—Transport des stérols et perception spécifique de l'ergostérol par la cellule végétale [Transport of sterols and specific perception of ergosterol by the plant cell]. Doctorate Thesis, University of Poitiers. 123 p.
(Ref 30) Sekiya J., Schmidt A., Wilson L. G., Filner P., 1982—Emission of hydrogen sulfide by leaf tissue in response to L-cysteine. Plant Physiol., 70: 430-436.
(Ref 31) Noctor G., Strohm M., Jouanin L, Kunert K. J., Foyer H., Rennenberg H., 1996—Synthesis of glutathione in leaves of transgenic poplar overexpressing γ-glutamylcysteine synthetase. Plant Physiol., 112: 1071-1078.
(Ref 32) Weinberg E. D., 1966—Roles of metallic ions in host-parasite interactions. Bacteriol. Rev., 30(1): 136-151.
(Ref 33) Brown A. E., Swinburne T. R., 1982—Iron-chelating agents and lesion development by Botrytis cinerea on leaves of Vicia faba. Physiol. Mol. Plant. P., 21: 13-21.
(Ref 34) Vedie R., Le Normand M., 1984—Modulation de l'expression du pouvoir pathogéne de Botrytis fabae Sard. et de Botrytis cinerea Pers. par des bacteries du phylloplan de Vicia faba L. [Modulation of expression of the pathogenic capacity of Botrytis fabae Sard. and of Botrytis cinerea Pers. by bacteria of the phylloplane of Vicia faba L.]. Agronomie, 4 (8): 721-728.
(Ref 35) Gouot J. M., 2006—Field efficacity of Profiler®, a fluopicolide and fosetyl-Al fungicide combianitio for the control of grape downy mildew (Plasmopara viticola). Pflanzenschutz-Nachrichten Bayer, 59: 293-302.
(Ref 36) Mazullo A., Calzarano F., Di Marco S., Cesari A., 2000—Experiences on the control of Esca disease fungi by fosetyl Al. Integrated Control in Viticulture. IOBC/wprs Bulletin, 23 (4): 77-78.
(Ref 37) Leconte F., Bonnemain J. L., de Cormis L., Barchietto T., 1988—Devenir métabolique, distribution, et formes de transport (systémie xylémienne et systémie phloémienne) du phoséthyl-Al chez Lycopersicon esculentum Mil. [Metabolic fate, distribution, and forms of transport (xylem systemics and phloem systemics) of fosetyl-Al in Lycopersicon esculentum Mil.]. C.R. Acad. Sci. III, 307: 221-227.
(Ref 38) Leroux P., 2000—La lutte chimique contre les maladies fongiques de la vigne: réflexion sur les stratégies anti-résistances [Chemical control of fungal diseases of grapevine: reflection on anti-resistance strategies]. Phytoma. La defense des végétaux, 533: 32-38.
(Ref 39) Dercks W., Creasy L. L., 1989—Influence of fosetyl Al on phytoalexin accumulation in the Plasmopara viticola-grapevine interaction. Physiol. Mol. Plant. P., 34 (3): 203-213.
(Ref 40) Lacombe J.-P., 2003—Comportement de l'association de fénamidone et de fosétyl d'aluminum face au mildiou resistant aux Qol [Behavior of the combination of fenamidone and fosetyl-aluminum against Qol-resistant mildew]. Phytoma. La defense des végétaux, 560: 45-50.
(Ref 41) Molina A., Hunt M. D., Ryals J. A., 1998—Impaired fungicide activity in plants blocked in disease resistance signal transduction. Plant Cell, 10: 1903-1914.
(Ref 42) Nemestothy G. S., Guest D. I., 1990—Phytoalexin accumulation, phenylalanine ammonia-lyase activity and ethylene biosynthesis in fosetyl Al treated resistant and susceptible tobacco cultivars infected with Phytophthora nicotianae var. nicotianae. Physiol. Mol. Plant. P., 37 (3): 207-219.
(Ref 43) Serrano M. L., Ferrer M. A., Calderon A. A., Muñoz R., Ros Barcelo A., Pedreño M. A., 1994—Aluminum-mediated fosetyl-Al effects on peroxidase secreted from grapevine cells. Environ. Exp. Bot., 34 (3): 329-336.
(Ref 44) Leroux P., 2003—Modes d'action des produits phytosanitaires sur les organismes pathogènes des plantes [Modes of action of plant protection products on plant pathogens]. C. R. Biologies, 326: 9-21.
(Ref 45) Ouimette D. G., Coffey M. D., 1990—Symplastic entry and phloem translocation of phosphonate. Pestic. Biochem, Phys., 38 (1): 18-25.
(Ref 46) Di Marco S., Mazzullo A., Calzarano F., Cesari A., 2000—The control of Esca: status and perspectives. Phytopathol. Mediterr., 29: 232-240.
(Ref 47) Mazullo A., Calzarano F., Di Marco S., Cesari A., 2000—Experiences on the control of Esca disease fungi by fosetyl Al. Integrated Control in Viticulture. IOBC/wprs Bulletin, 23 (4): 77-78.
(Ref 48) Di Marco S., Osti F., 2005—Effect of fosetyl Al foliar applications towards Esca fungi in grapevine. Phytopathol. Mediterr., 44: 114-115.
(Ref 49) Borie B., Jacquiot L, Jamaux-Despréaux I., Larignon P., Péros J.-P., 2002—Genetic diversity in populations of the fungi Phaeomoniella chlamydospora and Phaeoacremonium aleophilum on grapevine in France. Plant Pathol., 51: 85-96.
(Ref 50) Bearden J. C., 1978—Quantitation of submicrogram quantities of protein by an improved protein-dye binding assay. Biochim. Biophys. Acta, 533: 525-529.
(Ref 51) Leroux P., 1994—Influence du pH, d'acides amines et de diverses substances organiques sur la fongitoxicité du pyriméthanil, du glufosinate, du captafol, du cymoxanil, et du fenpiclonil vis-à-vis de certaines souches de Botrytis cinerea [Influence of pH, of amino acids and of various organic substances on the fungitoxicity of pyrimethanil, glufosinate, captafol, cymoxanil, and fenpiclonil against certain strains of Botrytis cinerea]. Agronomie, 14: 541-554
(Ref 52) Amborabé B. E., Octave S., Roblin G., 2005—Influence of temperature and nutritional requirements for mycelial growth of Eutypa lata, a vineyard pathogenic fungus. C. R. Biologies, 328: 263-270.
(Ref 53) Brun L., Geoffrion R., 2003—Mildiou de la vigne, cuivre et sol: une longue histoire commune [Grapevine mildew, copper and soil: a long history together]. Phytoma. La defense des végétaux, 564: 37-39.
(Ref 54) Colby S. R., 1967—Calculating synergistic and antagonistic responses of herbicide combinations. Weeds, 15: 20-22.

1. An antifungal composition comprising at least three of the compounds selected from the group comprising cysteine, salicylic acid, iron(II) sulfate and fosetyl-aluminum.

2. The composition according to claim 1 in which the composition comprises cysteine, salicylic acid, iron(II) sulfate and fosetyl-aluminum.

3. The composition according to claim 1, in which the concentration of cysteine is between 0.01 and 150 mM.

4. The composition according to claim 1, in which the concentration of salicylic acid is between 0.01 and 4 mM.

5. The composition according to claim 1, in which the concentration of iron(II) sulfate is between 0.01 and 160 mM.

6. The composition according to claim 1, in which the concentration of fosetyl-aluminum is between 0.01 and 81 mM.

7. A method of treating a plant, said method comprising application of the composition of claim 1.

8. A method of treatment and/or preventive treatment of a plant infected by a pathogen and/or that has a risk of infection by a pathogen, said method comprising application of the composition of claim 1.

9. The method of treatment according to claim 8, in which the pathogen is a fungus.

10. The method of treatment according to claim 8, in which application of the composition is carried out by spraying the plant.

11. The method of treatment according to claim 7, in which the plant is a grapevine.

12. The method according to claim 11, in which the fungus is Phaeomoniella chlamydospora and/or Phaeocremonium aleopholilum.

13. The composition according to claim 2, in which the concentration of cysteine is between 0.01 and 150 mM.

14. The composition according to claim 2, in which the concentration of salicylic acid is between 0.01 and 4 mM.

15. The composition according to claim 2, in which the concentration of iron(II) sulfate is between 0.01 and 160 mM.

16. The composition according to claim 2, in which the concentration of fosetyl-aluminum is between 0.01 and 81 mM.

17. The composition according to claim 3, in which the concentration of fosetyl-aluminum is between 0.01 and 81 mM.

18. The method of treatment according to claim 9, in which application of the composition is carried out by spraying the plant.

19. The method of treatment according to claim 9, in which the plant is a grapevine.

20. The method of treatment according to claim 10, in which the plant is a grapevine.

21. The method according to claim 19, in which the fungus is Phaeomoniella chlamydospora and/or Phaeocremonium aleopholilum.

22. The method according to claim 20, in which the fungus is Phaeomoniella chlamydospora and/or Phaeocremonium aleopholilum.
